(19) United States
(12) Patent Application Publication
(10) Pub. No.: US 2003/0130852 A1
(43) Pub. Date: Jul. 10, 2003

(54) Headset with radio communication function for speech processing system using speech recognition

(75) Inventors: Shinichi Tanaka, Kanagawa (JP); Yoichi Takebayashi, Kanagawa (JP); Hiroshi Kanazawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/334,989

(22) Filed: Jan. 2, 2003

(30) Foreign Application Priority Data
Jan. 7, 2002 (JP) 2002-000895

(51) Int. Cl. G10L 21/00

(52) U.S. Cl. 704/275

(57) ABSTRACT

A headset with a radio communication function is formed by a microphone configured to detect a speech and generate a speech signal indicating the speech, a speech recognition unit configured to recognize the speech indicated by the speech signal, a recognition result transmission unit configured to transmit a recognition result obtained by the speech recognition unit to an external device by radio communication, and a function selecting unit configured to enable a user of the headset to selectively control the speech processing unit to carry out a speech recognition processing of the speech signal generated by the microphone.

### BACKGROUND OF THE INVENTION

1. Field of the Invention

The present invention relates to a headset with a radio communication function, and more particularly to a headset with a radio communication function which is implemented with a speech recognition function and/or a speech transmission function and which is capable of improving a handling of these functions and reducing a power consumption, and a speech processing technique required between such a headset and a device implemented with a speech recognition function.

2. Description of the Related Art

Conventionally, an operation of a device naturally required manual operation of switches, keyboard, etc. When the operation of the device becomes more complicated, there has been a problem that the handling becomes more difficult as the number of switches increases or the operation sequence becomes complicated. Also, there has been an inconvenience in that the switches or keyboard cannot be operated when both hands are occupied.

In recent years, as a promising way of resolving these problems, the utilization of the speech recognition technique has started.

The device using the speech recognition technique can control a device operation in response to the content of the speech uttered by a user of the device, so that the operation of the device can be simplified considerably. In addition, it becomes possible to control home electronic devices, machines, robots, etc., located at distant locations by the speech any time from anywhere, and the mechanical (physical) switches can be reduced, so that its economical effect is large, and it has been attracting attention as a key technology in the era of ubiquitous.

In general, the device implemented with the speech recognition function for recognizing the input speech picks up the speech of the user by using a built-in microphone of the device or a microphone connected through a cable. The device has the pronunciation of the vocabulary (recognition vocabulary) that is the recognition target of the device, produces the word acoustic models constituting the recognition vocabulary according to the pronunciation in advance and stores them for the purpose of recognizing the speech input. The recognition of the input speech in this type of the speech recognition device is carried out as follows.

First, the speech signal detected by the microphone is acoustically analyzed, to obtain a feature parameter sequence. Next, the obtained feature parameter sequence of the speech signal is matched with the word acoustic models constituting the recognition vocabulary that are produced in advance, and the input speech is recognized.

In the speech recognition device, in the case where the microphone is provided in the device itself, if the user utters the speech at a position distanced from the device, the noises are superposed onto the speech signal detected by the microphone and the recognition performance is lowered. Consequently, in order to realize the recognition at high precision, the user must utter the speech by coming to a position close to the device. In the case where the microphone is connected to the device by a cable, when the microphone is located at a position distanced from the user, the user must utter the speech by coming to a position close to the microphone.

There can be cases where the microphone connected to the device is a close-talking type microphone arranged near the mouth of the user, but there is a problem that the cable connecting the device and the microphone can restrict the user's movable range. In the case of using a wireless type close-talking microphone, the action of the user is not restricted, but the electric noises are superposed onto the speech signal detected by the microphone so that the speech recognition performance is lowered.

Usually, in the speech recognition technique, the recognition result is outputted after a large amount of the signal processing and the matching processing. Unless these processings are carried out in almost real time, the device cannot carry out a corresponding operation quickly after the user has finished the speech utterance. For this reason, the device implemented with the speech recognition technique is required to have a sufficient computational power, and there has been a problem that it is difficult to implement the speech recognition technique to a cheap device or a device for which a compact size is required.

In recent years, the utilization of the portable electronic recording device has started. This is a device in which the speech signal is stored in a memory region inside the device and reproduce the stored speech, which is used for the purpose of recording the speech instead of writing a memo. It is also possible to transfer the stored speech to a device such as a PC through a cable, and store the speech data in a large capacity hard disk implemented on the PC. In the case where the speech recognition function is implemented on the PC, the stored speech data can be recognized by the speech recognition technique and converted into a text file.

In the speech memo, the speech recognition of the uttered sentences is carried out by the usual speech recognition technique as described above. Namely, the words that can possibly be used in the sentences are selected in advance, and these words constitute the recognition vocabulary. These words are often selected in the number of about several tens of thousand to one hundred thousand, but the number can be smaller than that when the topics are limited. The corresponding word acoustic models are produced in advance according to the pronunciation of the recognition vocabulary, and stored for the purpose of the recognition of the input speech. In addition, the language model indicating the likelihood of relationship among these words is produced in advance and stored for the purpose of the recognition of the input speech.

In the speech recognition, the stored speech data is acoustically analyzed to obtain a feature parameter sequence. Then, the obtained feature parameter sequence of the speech is matched with the word acoustic models of the recognition target words and the language model that are produced in advance, and the input speech is recognized.

However, in the portable electronic recording device, the internal memory region is often formed by a semiconductor memory in order to improve the portability, so that an amount of speeches that can be stored internally is limited. Also, at a time of transferring the stored speech to the PC or the like, there is a need to connect the device through a cable or use a removable medium, so that it is impossible to transfer the speech information to the other device in real time.

Also, in the case of using the device in a state of having both hands occupied, there is a need to connect a headset type microphone or a microphone with a clip to the portable electronic recording device through a cable. However, the cable restrict the user's action, and it is cumbersome to connect them at each occasion of using the device.

As described, in the conventional device using the speech recognition technique, in order to recognize the speech accurately, the user is required to use the device while constantly paying attention to the positional relationship between the user and the microphone, and to utter the speech by coming close to the microphone according to the need.

Also, in the case of using the headset type microphone, there has been a problem that the user's action is restricted by the cable for connecting the microphone and the device. In the case of the headset that does not have a computation capacity required for the speech recognition technique, the operation by the speech itself is impossible.

Also, in the portable electronic recording device, the amount of the speech data that can be stored internally is limited, and the stored data cannot be transferred to the other device in real time. Also, there is a need to connect the microphone by the cable, but the cable can restrict the user's action and it is cumbersome to connect the cable.

### BRIEF SUMMARY OF THE INVENTION

It is therefore an object of the present invention to provide a headset with a radio communication function capable of realizing the speech recognition technique at high precision without restricting the user's action.

It is another object of the present invention to provide a headset with a radio communication function capable of transferring the speech data to the other device in real time.

It is another object of the present invention to provide a headset with a radio communication function capable of reducing a power consumption by providing a function selecting mechanism for stopping the speech recognition function or the speech transmission function whenever it is unnecessary.

It is another object of the present invention to provide a speech processing system capable of transferring the speech data from the headset to another device in real time and carry out the speech recognition at the another device.

It is another object of the present invention to provide a speech processing system in which the operation of one device is controlled by transmitting the speech recognition result through radio from another device to the one device.

According to one aspect of the present invention there is provided a headset with a radio communication function, comprising: a microphone configured to detect a speech and generate a speech signal indicating the speech; a speech recognition unit configured to recognize the speech indicated by the speech signal; a recognition result transmission unit configured to transmit a recognition result obtained by the speech recognition unit to an external device by radio communication; and a function selecting unit configured to enable a user of the headset to selectively control the speech processing unit to carry out a speech recognition processing of the speech signal generated by the microphone.

According to another aspect of the present invention there is provided a speech processing system, comprising: a headset with a radio communication function, comprising: and an external device capable of carrying out radio communication with the headset; wherein the headset has: a microphone configured to detect a speech of a user of the headset and generate a speech signal indicating the speech; a speech recognition unit configured to recognize the speech indicated by the speech signal, and generate an identification signal corresponding to the speech as recognized from the speech signal; and a recognition result transmission unit configured to transmit the identification signal generated by the speech recognition unit as a recognition result to the external device by radio communication, such that the external device carries out an operation corresponding to the identification signal received from the headset.

According to another aspect of the present invention there is provided a speech processing system, comprising: a headset with a radio communication function, comprising: and an external device capable of carrying out radio communication with the headset and having a speech recognition function; wherein the headset has: a microphone configured to detect a speech of a user of the headset and generate a speech signal indicating the speech; a headset side speech recognition unit configured to recognize the speech indicated by the speech signal; and a speech transmission unit configured to transmit the speech signal to the external device by radio communication; and the external device has: a speech receiving unit configured to receive the speech signal transmitted from the headset; and a device side speech recognition unit configured to recognize the speech indicated by the speech signal.

According to another aspect of the present invention there is provided a speech processing system, comprising: a headset with a radio communication function, comprising: a first external device capable of carrying out radio communication with the headset and having a speech recognition function; and a second external device capable of carrying out radio communication with the first external device; wherein the headset has: a microphone configured to detect a speech of a user of the headset and generate a speech signal indicating the speech; a headset side speech recognition unit configured to recognize the speech indicated by the speech signal; and a speech transmission unit configured to transmit the speech signal to the first external device by radio communication; and the first external device has: a speech receiving unit configured to receive the speech signal transmitted from the headset; a device side speech recognition unit configured to recognize the speech indicated by the speech signal, and generate an identification signal corresponding to the speech as recognized from the speech signal; and a recognition result transmission unit configured to transmit the identification signal as a recognition result to the second external device by radio communication, such that the second external device carries out an operation corresponding to the identification signal received from the first external device.

Other features and advantages of the present invention will become apparent from the following description taken in conjunction with the accompanying drawings.

### BRIEF DESCRIPTION OF THE DRAWINGS

FIG. 1 is a diagram showing an overview of a headset with a radio communication function according to the first embodiment of the present invention.

FIG. 2 is a schematic block diagram showing a configuration of the headset of FIG. 1.

FIG. 3 is a diagram showing an example of a function selecting switch in the headset of FIG. 1.

FIG. 4 is a block diagram showing an exemplary internal configuration of a speech recognition unit in the headset of FIG. 1.

FIG. 5 is a diagram showing an exemplary memory content of a recognition vocabulary memory unit in the speech recognition unit of FIG. 4.

FIG. 6 is a diagram showing an exemplary memory content of an air conditioner to be controlled by using the headset of FIG. 1.

FIGS. 7A and 7B are schematic diagrams showing exemplary operations of the headset of FIG. 1 using the function switching unit of FIG. 2.

FIG. 8 is a schematic block diagram showing a configuration of a headset with a radio communication function according to the second embodiment of the present invention.

FIG. 9 is a diagram showing an example of a function selecting switch in the headset of FIG. 8.

FIG. 10 is a block diagram showing an exemplary internal configuration of a speech transmission section in the headset of FIG. 8.

FIGS. 11A and 11B are schematic diagrams showing exemplary operations of the headset of FIG. 8 using the function switching unit of FIG. 9.

FIG. 12 is a schematic block diagram showing a configuration of a headset with a radio communication function according to the third embodiment of the present invention.

FIG. 13 is a diagram showing an example of a function selecting switch in the headset of FIG. 12.

FIGS. 14A and 14B are schematic diagrams showing exemplary operations of the headset of FIG. 12 using the function switching unit of FIG. 13.

FIG. 15 is a schematic diagrams showing another exemplary operation of the headset of FIG. 12 using the function switching unit of FIG. 13.

FIG. 16 is a schematic block diagram showing a configuration of a headset with a radio communication function according to the fourth embodiment of the present. invention.

FIG. 17 is a diagram showing an example of a function selecting switch in the headset of FIG. 16.

FIGS. 18A and 18B are schematic diagrams showing exemplary operations of the headset of FIG. 16 using the function switching unit of FIG. 17.

FIG. 19 is a schematic diagrams showing another exemplary operation of the headset of FIG. 16 using the function switching unit of FIG. 17.

FIG. 20 is a schematic block diagram showing a configuration of a headset with a radio communication function according to the fifth embodiment of the present invention.

FIG. 21 is a diagram showing an example of a function selecting switch in the headset of FIG. 20.

FIGS. 22A and 22B are schematic diagrams showing exemplary operations of the headset of FIG. 20 using the function switching unit of FIG. 21.

FIGS. 23A and 23B are schematic diagrams showing other exemplary operations of the headset of FIG. 20 using the function switching unit of FIG. 21.

FIG. 24 is a schematic block diagram showing a configuration of a speech processing system according to the sixth embodiment of the present invention.

FIG. 25 is a block diagram showing an exemplary configuration of a speech receiving unit in a device with a speech recognition function in the speech processing system of FIG. 24.

FIG. 26 is a block diagram showing an exemplary configuration of a speech recognition engine in a device with a speech recognition function in the speech processing system of FIG. 24.

FIG. 27 is a schematic diagrams showing an exemplary operation of the speech processing system of FIG. 24.

FIG. 28 is a diagram showing an exemplary memory content of a recognition vocabulary memory unit in the speech recognition engine of FIG. 26.

FIG. 29 is a diagram showing an exemplary memory content of a language model memory unit in the speech recognition engine of FIG. 26.

FIG. 30 is a diagram showing an exemplary display by a device with a speech recognition function in the speech processing system of FIG. 24.

FIG. 31 is a schematic block diagram showing a configuration of a speech processing system according to the seventh embodiment of the present invention.

FIG. 32 is a block diagram showing an exemplary configuration of a speech recognition engine in a device with a speech recognition function in the speech processing system of FIG. 24.

FIG. 33 is a schematic diagrams showing an exemplary operation of the speech processing system of FIG. 31.

FIG. 34 is a diagram showing an exemplary memory content of a recognition vocabulary memory unit in the speech recognition engine of FIG. 32.

FIG. 35 is a diagram showing an exemplary memory content of an air conditioner to be controlled by using the speech processing system of FIG. 31.

### DETAILED DESCRIPTION OF THE INVENTION

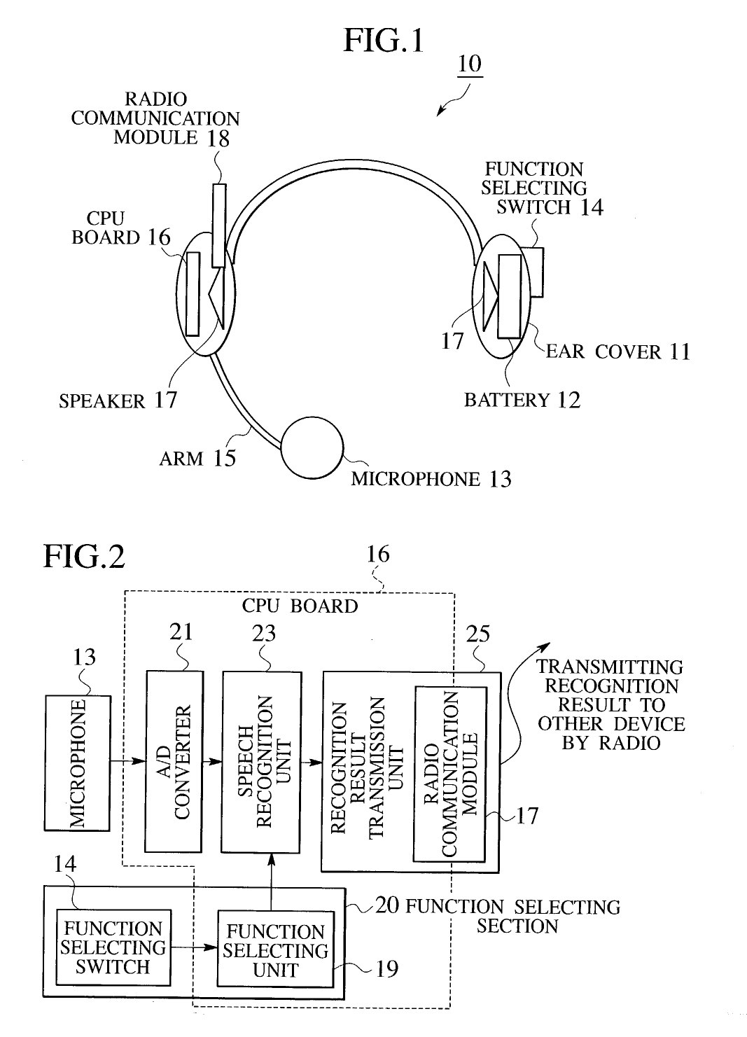

Referring now to FIG. 1 to FIG. 35, the embodiments of the present invention will be described in detail.

(First Embodiment)

FIG. 1 and FIG. 2 respectively show an outward appearance and a schematic system configuration of a headset 10 with a radio communication function according to the first embodiment of the present invention. The headset 10 with the radio communication function has a microphone 13 for detecting the speech uttered by a wearer (user) of the headset 10 and generating electric speech signal, a speech recognition unit 23 for recognizing the speech through digital conversion of the speech signal, a recognition result transmission unit 25 for transmitting the recognition result of the speech recognition unit 23 to an external device from a radio communication module 18, and a function selecting section 20 for selecting whether or not to apply the speech recognition processing to the speech signal detected by the microphone 13. The function selecting section 20 includes a function selecting switch 14, such that the user can select the speech recognition processing arbitrarily by operating the function selecting switch 14.

The headset 10 with the radio communication function (which will also be simply referred to as “headset” in the following) has a shape in which left and right ear covers 11 are connected by a flexible frame, and is used by being worn on the head of the user. An arm 15 is extending from one ear cover 11, and the microphone 13 is provided at an end of the arm 15. The microphone 13 is arranged to be near the mouth of the user when the headset 10 is worn by the user, so as to detect the speech with little surrounding noise superposed thereon.

Inside the ear cover 11, (left and right) speakers 17, a CPU board 16, a radio communication module 18, and a battery 12 are provided. The function selecting switch 14 is arranged on an outer side of one ear cover 11 such that the user can select whether or not to carrying out the speech recognition processing intentionally as described. Note that the above described elements are connected through cables according to the need, although the cables are not shown in the figures.

The CPU board 16 is implemented with a CPU and its peripheral circuits (not shown), a memory (not shown), an A/D converter 21, and a function selecting unit 19. The A/D converter 21 converts the analog speech signal detected by the microphone 13 into the digital speech signal, and inputs the conversion result into the CPU. The function selecting unit 19 detects a state of the function selecting switch 14 and notifies it to the CPU.

The radio communication module 18 carries out the digital radio communications with the external device. More specifically, it has a transmission/reception function by which signals sent from the CPU board 16 are transmitted to the other device (not shown), and signals transmitted from the other device are received transferred to the CPU board 16.

The speech recognition section includes the A/D converter 21 and the speech recognition unit 23 on the CPU board 16. The speech transmission unit 25 is realized by the CPU and its peripheral circuits on the CPU board 16 and the radio communication module 18. The function selecting section 20 is realized by the function selecting switch 14 and the CPU and its peripheral circuits on the CPU board 16, and its output is connected to the speech recognition unit 23. As described above, the user can control the processing operation of the speech recognition unit 23 by operating the function selecting switch 14.

Note that the outward appearance and the system configuration of the headset 10 shown in FIG. 1 and FIG. 2 are only an exemplary configuration for realizing the present invention, and the present invention is not limited to this configuration. It is possible to provide a circuit dedicated for the speech recognition processing as the speech recognition unit 23. It is also possible to provide a DSP for carrying out the signal processing at high speed. It is also possible to provide the function selecting switch 14 on each one of the two ear covers 11.

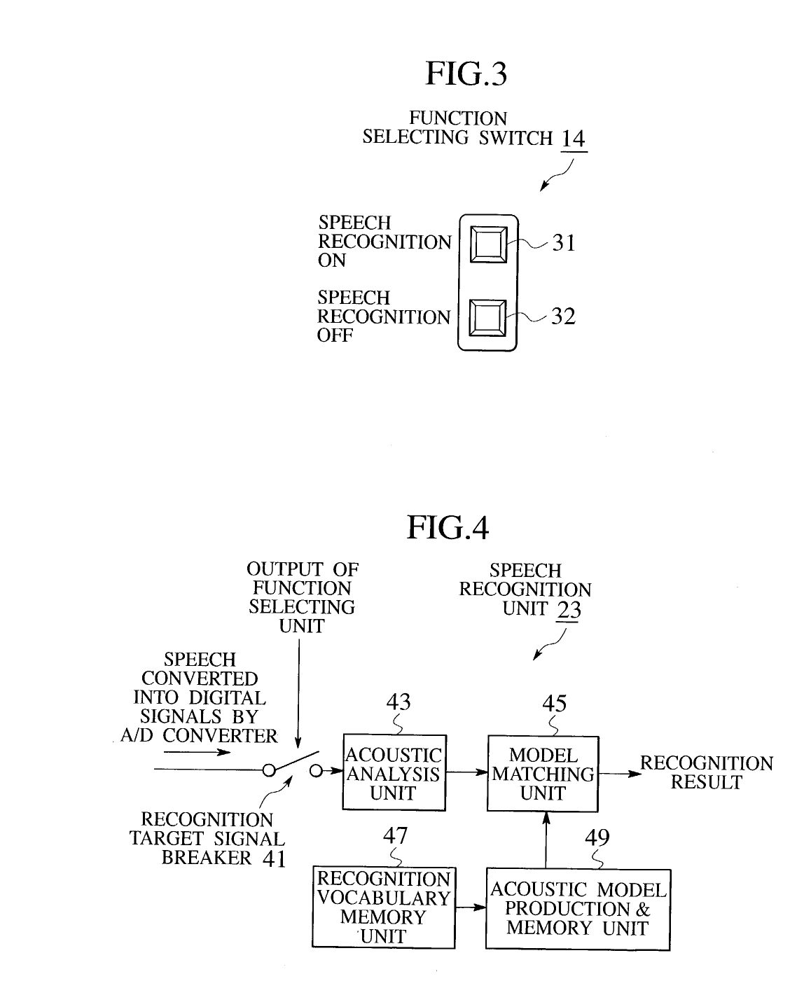

FIG. 3 shows an example of the function selecting switch 14. The user can switch two states by operating the function selecting switch 14 according to the need. Here, the case where the user selected to process the speech signal detected by the microphone 13 at the speech recognition unit 23 is referred to as a state #1, and the case where the user selected not to process it is referred to as a state #2.

The function selecting switch 14 has two push button switches, for example, and it is a type of the switch in which either one of them is always ON. When the user presses the push button switch 31 to turn it ON, the function selecting switch 14 is in the state #1. In conjunction with this, the press button switch 32 is automatically turned OFF. Conversely, when the user presses the push button switch 32 to turn it ON, the function selecting switch 14 is in the state #2, and the press button switch 31 is automatically turned OFF. The function selecting unit 19 outputs a speech recognition operation signal to the speech recognition unit 23 if the state of the function selecting switch 14 is the state #1, or outputs a speech recognition stop signal to the speech recognition unit 23 if the state of the function selecting switch 14 is the state #2.

The speech recognition unit 23 recognizes the speech signal detected by the microphone 13 and sends its output to the recognition result transmission unit 25 when the output of the function selecting unit 19 is the speech recognition operation signal, or stops its operation when the output of the function selecting unit 19 is the speech recognition stop signal.

FIG. 4 shows an internal configuration of the speech recognition unit 23. The output of the A/D converter 21 is first inputted into a recognition target signal breaker 41. The operation of the recognition target signal breaker 41 is controlled by the output signal of the function selecting unit 19. When the output of the function selecting unit 19 is the speech recognition operation signal, the signal outputted from the A/D converter 21 is inputted into an acoustic analysis unit 43. When the output of the function selecting unit 19 is the speech recognition stop signal, the signal outputted from the A/D converter 21 is blocked.

More specifically, when the output of the function selecting unit 19 is the speech recognition operation signal, the recognition target signal breaker 41 is closed so that the digital speech signal outputted from the A/D converter 21 is inputted into the acoustic analysis unit 43. The acoustic analysis unit 43 converts the inputted speech into feature parameters. The representative feature parameters often used in the speech recognition include the power spectrum that can be obtained by the band-pass filter or the Fourier transform, and the cepstrum coefficients that can be obtained by the LPC (Linear Predictive Coding) analysis, but the types of the feature parameters to be used can be any of them. The acoustic analysis unit 43 converts the input speeches for a prescribed period of time into the feature parameters. Consequently, its output is a time series of the feature parameters (feature parameter sequence). This feature parameter sequence is supplied to a model matching unit 45.

On the other hand, a recognition vocabulary memory unit 47 stores a word pronunciation information necessary for producing the acoustic model of each word that constitutes the recognition vocabulary, and indentifier corresponding to the recognition result in the case where each word is recognized, such as a command ID, for example. Note that, in this embodiment, an exemplary case of using the speech control by the word recognition will be described as the speech recognition inside the headset, but the present invention is not limited to this case. The speech recognition unit 23 in the headset can carry out the speech recognition that requires the small amount of calculations, the small memory capacity and the small power consumption such as the continuous word recognition, the sentence recognition, the word spotting, the speech intention comprehension, etc., and transmits its result to the external device system by the radio communication.

An acoustic model production and memory unit 49 stores in advance the acoustic model of each word and a word ID to be used as an identification signal to be outputted from the model matching unit 45 as a recognition result when each word is recognized, according to the recognition vocabulary stored in the recognition vocabulary memory unit 47. Of course, in the case of carrying out the recognition other than the word recognition, the acoustic model production and memory unit 49 stores the identification signal suitable for that recognition to be carried out.

The model matching unit 45 calculates a similarity or a distance between the acoustic model of each recognition target word stored in the acoustic model production and memory unit 49 and the feature parameter sequence of the above described input speech, and outputs a word ID set in correspondence to the acoustic model for which the similarity is highest (or the distance is smallest) as the recognition result.

As the matching method of the model matching unit 45, the widely used ones include a method in which the acoustic model is also expressed as the feature parameter sequence and the distance between the feature parameter sequence of the acoustic model and the feature parameter sequence of the input speech is calculated by the DP (Dynamic Programming) matching, and a method using the HMM (Hidden Markov Model) as the acoustic model in which the probability by which the input speech is outputted from each acoustic model is calculated, but any matching method can be used.

The word ID outputted from the model matching unit 45 becomes the output of the speech recognition unit 23, and inputted into the recognition result transmission unit 25 (see FIG. 2). The recognition result transmission unit transmits the word ID to the other device by radio, using the transmission function of the radio communication module 17.

When the output of the function selecting unit 19 is the speech recognition stop signal, the recognition target signal breaker 41 is opening so that the A/D converted signals are not inputted into the acoustic analysis unit 43. Consequently, there is no output from the acoustic analysis unit 43. Similarly, there is no input into the model matching unit 45 so that there is no output from the model matching unit 45 either.

In this way, when the user of the headset 10 selected not to carry out the processing of the speech recognition unit 23 (that is, when the state of the function selecting switch 14 is the state #2), the series of processing by the acoustic analysis unit 43, the model matching unit 45 and the recognition result transmission unit 25 will not be carried out. In this case, the amount of calculations is reduced considerably.

When the CPU that realizes the acoustic analysis unit 43, the model matching unit 45 and the recognition result transmission unit 25 has a power saving mode for temporarily reducing the computational power and the power consumption, it is possible for the CPU to make a transition to the power saving mode when the state of the function selecting switch 14 becomes the state #2 or when the speech recognition stop signal is detected. While the user is selecting not to carry out the processing of the speech recognition unit 23, the CPU will be operates in the power saving mode so that the load on the battery is reduced and it becomes possible to prolong the operable period of the headset with the radio communication function. When the function selecting switch 14 comes out of the state #2 (that is, when the speech recognition operation signal is outputted), the CPU makes the transition to the ordinary mode immediately such that the normal computational power becomes available.

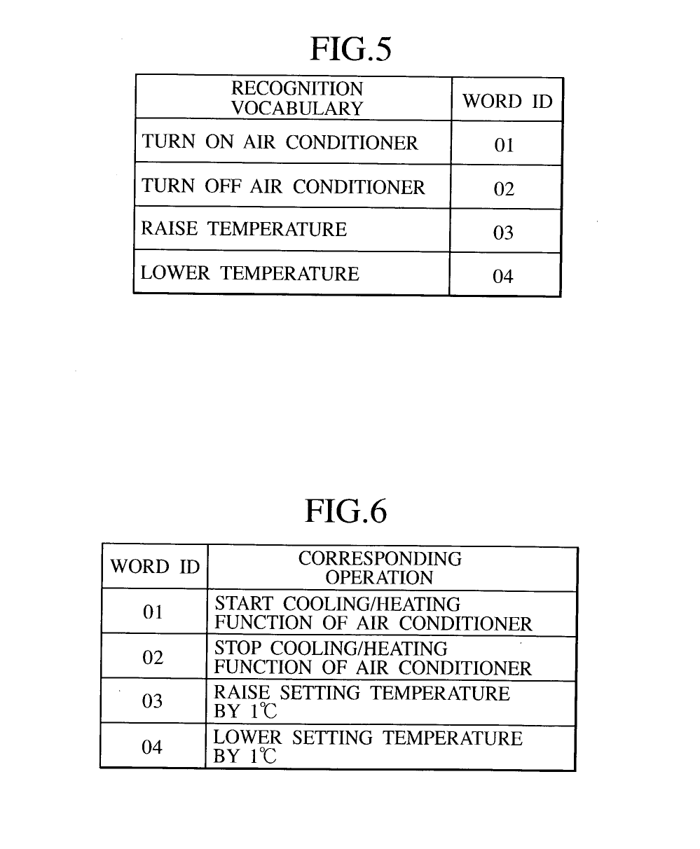

FIG. 5 shows an exemplary memory content of the recognition vocabulary memory unit 47 provided in the headset. In this example, the user wearing the headset 10 carries out the control of the air conditioner by the speech commands. Consequently, the recognition result obtained by the speech recognition unit 23 from the speech uttered by the user is transmitted to the air conditioner by the radio communication.

In the example of FIG. 5, the recognition vocabulary include “turn on air conditioner”, “turn off air conditioner”, “raise temperature”, and “lower temperature”, and the word IDs “01”, “02”, “03”, and “04” are assigned to them respectively. In the case where speech “turn on air conditioner” uttered by the user is recognized by the speech recognition unit 23 of the headset 10, the word ID “01” is transmitted by radio to the air conditioner.

According to the memory content of the recognition vocabulary memory unit 47, the memory content of the acoustic model production and memory unit 49 is produced. In the case of the exemplary memory content shown in FIG. 5, the acoustic models for the speeches “turn on air conditioner”, “turn off air conditioner”, “raise temperature”, and “lower temperature” are produced, and stored in correspondence to the respective identification signals (word IDs).

On the other hand, the air conditioner stores a set of each word ID and its corresponding operation as shown in FIG. 6. Consequently, when the speech recognition result (that is, the word ID) from the headset is received, the air conditioner carries out the operation corresponding to that word ID.

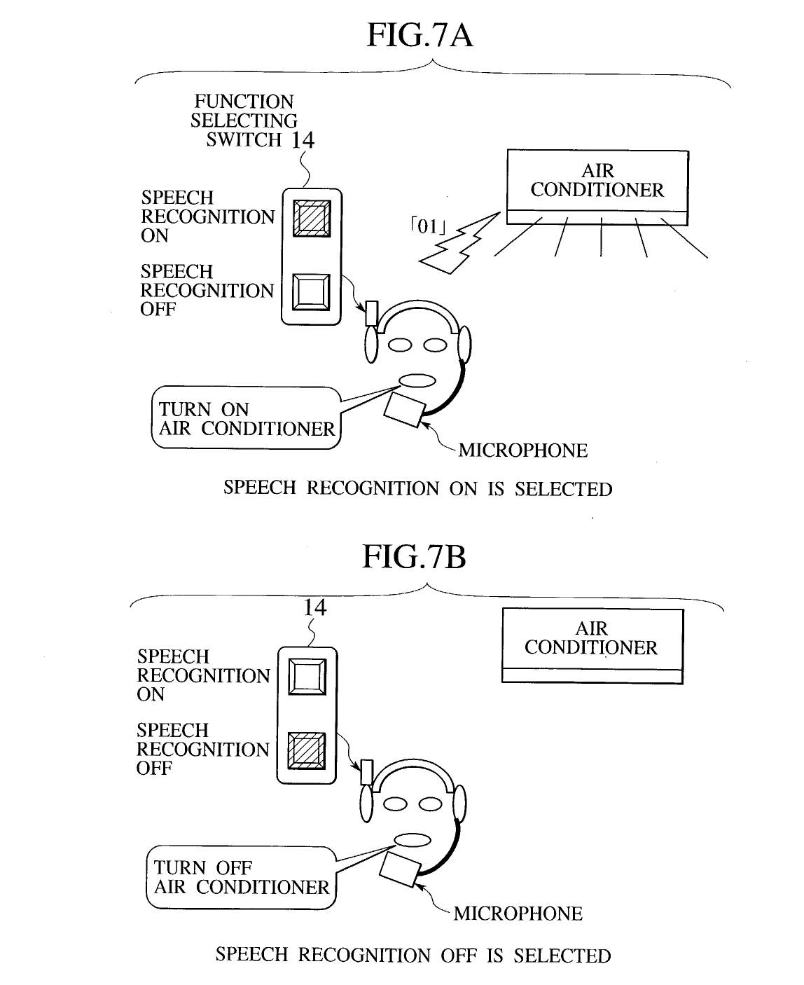

FIG. 7A shows the case where the user of the headset uttered “turn on air conditioner” in the state where the speech recognition processing mode is selected by the function selecting switch 14. The speech uttered by the user is detected by the microphone, and converted into the digital signal by the A/D converter 21. As the state of the function selecting switch 14 is the state #1, the function selecting unit 19 outputs the speech recognition operation signal. Consequently, the recognition target signal breaker 41 is closed and the digital signal is inputted into the acoustic analysis unit 43 and converted into the feature parameter sequence, which is inputted into the model matching unit 45. The model matching unit 45 matches the inputted feature parameter sequence and the acoustic model of each word stored in the acoustic model production and memory for “turn on air conditioner” becomes highest, and the model matching unit 45 outputs the word ID “01” as the recognition result.

The word ID “01” is inputted into the recognition result transmission unit 25, and this word ID “01” is transmitted to the air conditioner.

When the word “01” is received, the air conditioner starts the operation of the cooling/heating function according to the correspondence table of FIG. 6.

FIG. 7B shows the case where the user of the headset uttered “turn on air conditioner” in the state where the no speech recognition processing mode is selected by the function selecting switch 14. The speech uttered by the user is detected by the microphone, and converted into the digital signal by the A/D converter 21. As the state of the function selecting switch 14 is the state #2, the function selecting unit 19 outputs the speech recognition stop signal. Consequently, the recognition target signal breaker 41 is opening and the digital signal is not inputted into the acoustic analysis unit 43. In this case, the recognition result is not obtained, so that the recognition result is not transmitted to the air conditioner, and the air conditioner does not start any operation.

In the above described headset 10 with the radio communication function, the user's speech is detected by using the microphone 13 associated with the headset. This microphone 13 is arranged near the mouth of the user so that the speech signal detected by the microphone 13 is superposed with little surrounding noise, such that the high recognition performance can be realized at a time of recognizing that speech.

The recognized speech command is transmitted to the other device by the radio communication so that there is no need for the cable, and the user's action will not be restricted.

The speech recognition is carried out at the headset 10 side so that the device having a function for carrying out the radio communication with this headset 10 can be operated by the speech uttered by the user, even when that device is not implemented with the speech recognition function.

In addition, the function selecting section for selecting whether or not to carrying out the speech recognition processing is provided so that the user can select not to carry out the speech recognition processing of the speech uttered by himself according to the intention of the user. During the speech recognition processing, the large amount of calculations are carried out in real time to process the detected speech signal so that there is a need to drive the calculation device at high speed operation clock, but in the case of not carrying out the speech recognition processing of the speech, the calculations related to the speech recognition become unnecessary, and it is possible to lower the operation clock of the calculation device.

The calculation device requires a higher power consumption for the faster operation clock, so that by stopping the processing of the speech recognition unit, it is possible to lower the power consumption of the headset with the radio communication function considerably. The headset with the radio communication function cannot receive the power supply from the external and is operated by the battery or the storage cell. Consequently, the lowering of the power consumption can prolong the operable period of the headset with the radio communication function, and thereby improve the usefulness of the headset with the radio communication function.

(Second Embodiment)

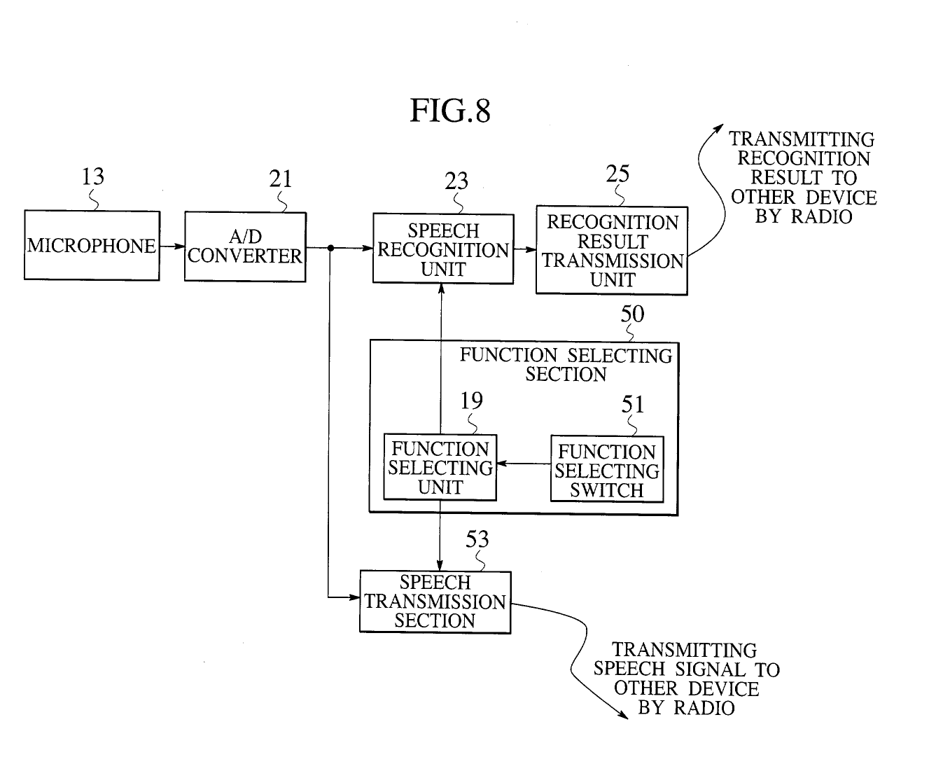

FIG. 8 shows a system configuration of the headset according to the second embodiment of the present invention. The first embodiment is directed to the case where the speech signal is simply analyzed and matched by the speech recognition unit and the identification (ID) signal corresponding to the speech uttered by the user is transmitted to the control target external device by radio. The second embodiment is directed to the case where, in addition to the speech recognition inside the headset, the speech data before the speech recognition is transmitted to the other device in real time by radio.

First, the speech signal detected by the microphone is inputted into the A/D converter 21, and converted from the analog signal to the digital speech signal. The digital speech signal is split into two parts, and one is inputted into the speech recognition unit 23 while the other one is inputted into a speech transmission section 53.

A function selecting section 50 is formed by a function selecting switch 51 and the function selecting unit 19. The user can switch two states by operating the function selecting switch 51 according to the need. Here, the case where the user selected to process the speech signal detected by the microphone 13 at the speech recognition unit 23 is referred to as a state #1, and the case where the user selected to process the speech signal detected by the microphone 13 at the speech transmission section 53 is referred to as a state #2.

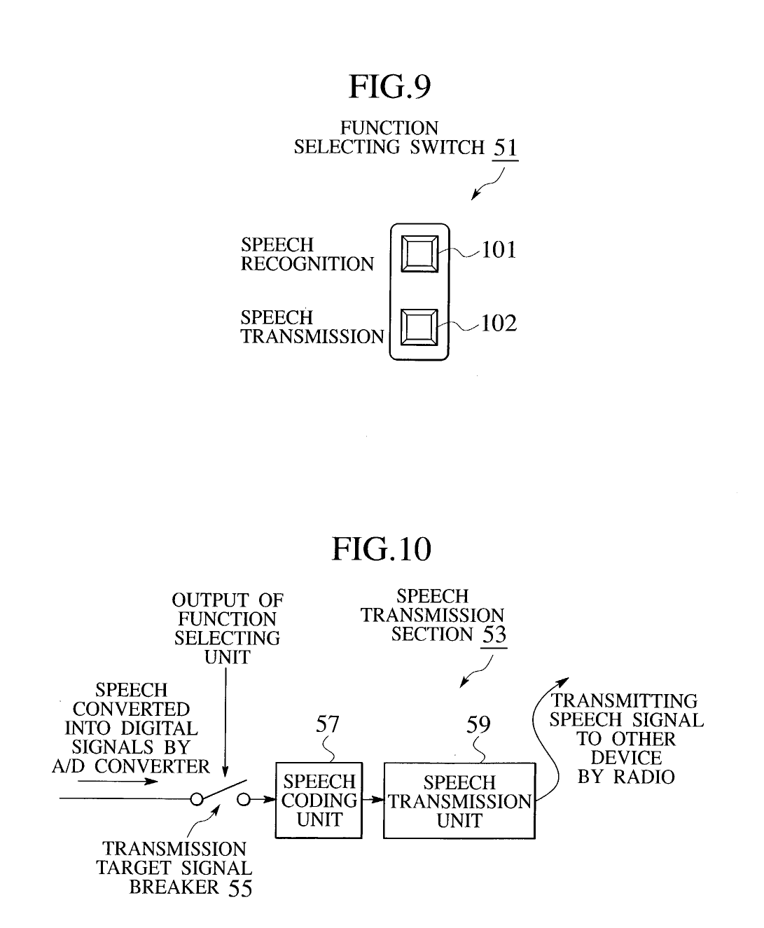

FIG. 9 shows an example of the function selecting switch 51. The function selecting switch 51 has two push button switches, for example, and it is a type of the switch in which either one of them is always ON. When the user presses the push button switch 101 to turn it ON, the function selecting switch 51 is in the state #1. In conjunction with this, the press button switch 102 is automatically turned OFF. When the user presses the push button switch 102 to turn it ON, the function selecting switch 51 is in the state #2. In conjunction with this, the press button switch 101 is automatically turned OFF. The function selecting unit 19 outputs a speech recognition operation signal to the speech recognition unit 23 while also outputting a speech transmission stop signal to the speech transmission section 53 if the state of the function selecting switch 51 is the state #1, or outputs a speech recognition stop signal to the speech recognition unit 23 while also outputting a speech transmission operation signal to the speech transmission section 53 if the state of the function selecting switch 51 is the state #2.

FIG. 10 shows an internal configuration of the speech transmission section 53. The speech signal converted into the digital signal by the A/D converter 21 is first inputted into a transmission target signal breaker 55. When the output signal of the function selecting unit 19 is the speech transmission operation-signal, the transmission target signal breaker 55 is closed and the signal outputted from the A/D converter 21 is inputted into a speech coding unit 57. When the output of the function selecting unit 19 is the speech transmission stop signal, the transmission target signal breaker 55 is opened and the signal outputted from the A/D converter 21 is blocked.

The speech coding unit 57 encodes the digital speech signal inputted through the transmission target signal breaker 55 by a prescribed method. The processing for encoding the digital speech signal may include the compression processing by the ADPCM or the like, the attaching of coding parameters or information for correcting the transmission errors, etc., but the concrete processing content can be any of them.

The coded data are inputted into a speech transmission unit 59. The speech transmission unit 59 transmits the coded data to the other device by radio, by utilizing the transmission function of the radio communication module 18 (FIG. 1).

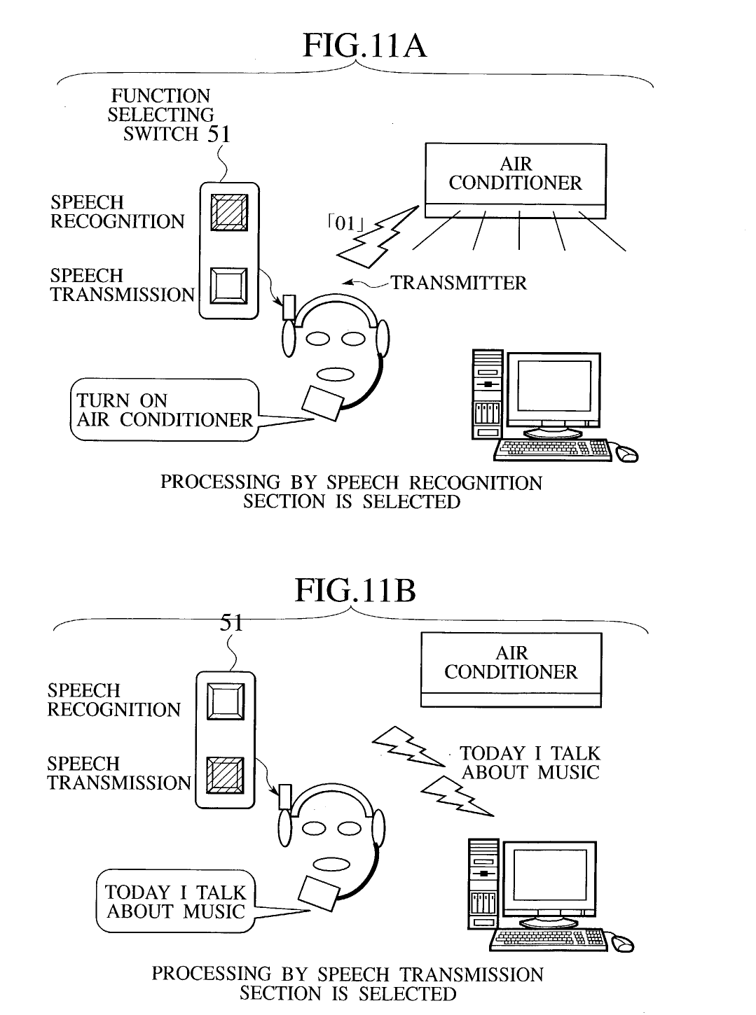

FIGS. 11A and 11B show exemplary operations of the headset with the radio communication function according to the second embodiment. Here, the exemplary case where the user controls both an air conditioner and a PC which are located inside a room, by using the headset with the radio communication function will be described. The speech of the user picked up by the microphone is transmitted by radio to the air conditioner as an output of the recognition result transmission unit 25 on one hand, and to the PC as an output (coded data) of the speech transmission section 53 on the other hand.

The memory contents of the recognition vocabulary memory unit 47 and the acoustic model production and memory unit 49 of the speech recognition unit 23 within the headset as well as the memory content on the air conditioner side are assumed to be the same as in the first embodiment. It is also assumed that the PC is connected to a large capacity hard disk, and the speech data received from the headset with the radio communication function are all stored into this hard disk.

FIG. 11A shows the case where the user uttered the speech command “turn on air conditioner” in the state where the speech recognition processing mode is selected by the function selecting switch 51. The speech uttered by the user is detected by the microphone, and converted into the digital signal by the A/D converter 21. The digital signal is split into two, and one is inputted into the speech recognition unit 23 while the other one is inputted into the speech transmission section 53 as described above.

At this point, as the state of the function selecting switch 51 is the state #1, the function selecting unit 19 outputs the speech recognition operation signal to the speech recognition unit 23, and outputs the speech transmission stop signal to the speech transmission section 53.

The digital signal inputted into the speech recognition unit 23 is first inputted into the recognition target signal breaker 41. The recognition target signal breaker 41 is closed according to the speech recognition operation signal from the function selecting unit 19, so that the digital signal is inputted into the acoustic analysis unit 43. The model matching and subsequent processing are the same as in the first embodiment. Namely, the model matching unit 45 outputs the identification signal “01” as the recognition result, and this identification signal “01” is transmitted to the air conditioner by radio from the recognition result transmission unit 25.

On the other hand, the digital signal inputted into the speech transmission section 53 is inputted into the transmission target signal breaker 55. As the function selecting unit 19 outputs the speech transmission stop signal, the recognition target signal breaker 55 is opening and the digital signal is not inputted into the speech coding unit 57, and the subsequent processing is not carried out.

FIG. 11B shows the case where the user uttered the speech “Today I talk about music” in the state where the speech transmission processing mode is selected by the function selecting switch 51. The speech uttered by the user is detected by the microphone, and converted into the digital signal by the A/D converter 21. The digital signal is split into two, and one is inputted into the speech recognition unit 23 while the other one is inputted into the speech transmission section 53.

At this point, as the state of the function selecting switch 51 is the state #2, the function selecting unit 19 outputs the speech recognition stop signal to the speech recognition unit 23, and outputs the speech transmission operation signal to the speech transmission section 53.

The digital signal inputted into the speech recognition unit 23 is first inputted into the recognition target signal breaker 41. The recognition target signal breaker 41 is opening as the function selecting unit 19 outputs the speech recognition stop signal. Consequently, the digital signal is not inputted into the acoustic analysis unit 43 and the subsequent processing is not carried out.

On the other hand, the digital signal inputted into the speech transmission section 53 is inputted into the transmission target signal breaker 55. As the function selecting unit 19 outputs the speech transmission operation signal, the recognition target signal breaker 55 is closed. Consequently, the digital signal is encoded at the speech coding unit 57, and transmitted by radio from the speech transmission unit 59 to the PC through the radio communication module 18.

The PC decodes the coded speech transmitted from the headset into the digital speech signal, and records it into the hard disk. Namely, the content uttered by the user is recorded in the PC by using the radio communication from the headset. The PC has a sufficient capacity so that the content uttered by the user can be stored either as the speech or in a state after the text conversion. Also, the recorded speech can be retrieved and reproduced whenever necessary.

Also, as will be described below, in the case where the speech recognition function is provided in the PC, it is possible to apply the high precision speech recognition processing with respect to the speech signal transmitted from the headset.

With this configuration, the user who wear the headset with the radio communication function can carry out the processing of the speeches targeting a plurality of devices, according to his own selection, in the hand-free state. For example, in addition to the control of the other device by the speech commands, it also becomes possible to record the content uttered by the user himself in real time.

(Third Embodiment)

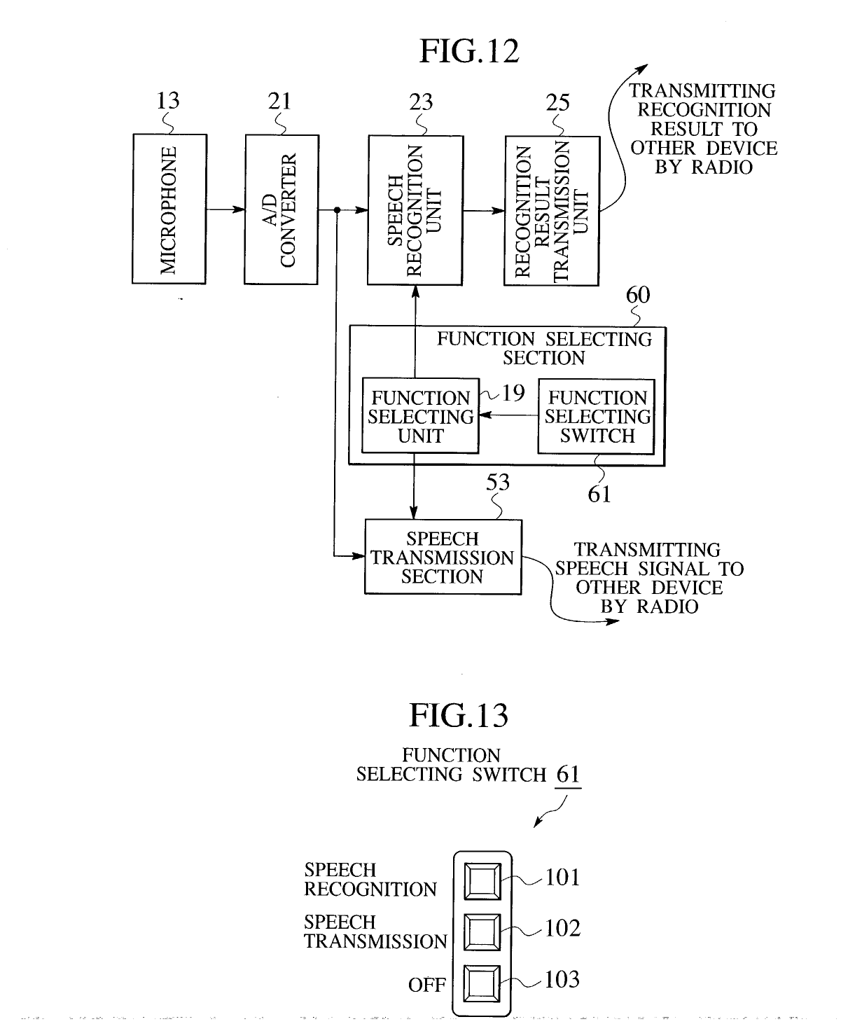

FIG. 12 and FIG. 13 show a system configuration of the headset according to the third embodiment of the present invention.

In the third embodiment, similarly as in the second embodiment, the speech signal can be processed by the speech recognition processing for the speech commands as well as by the transmission processing for the radio transmission of the speech data. In the third embodiment, in addition to these two processing modes, an OFF mode for not carrying out both of these processings is added to the function selecting switch.

As shown in FIG. 12 and FIG. 13, a function selecting section 60 is formed by a function selecting switch 61 and the function selecting unit 19. The user can switch three states by operating the function selecting switch 61 according to the need. Here, the case where the user selected the speech recognition processing of the uttered speech is referred to as a state #1, the case where the user selected the speech transmission processing of the speech is referred to as a state #2, and the case where the user selected not to process the speech by either the speech recognition unit or the speech transmission section is referred to as a state #3.

FIG. 13 shows an example of the function selecting switch 61. The function selecting switch 61 has three push button switches, for example, and it is a type of the switch in which any one of them is always ON. When the user presses the push button switch 101 to turn the speech recognition ON, the function selecting switch 61 is in the state #1. In conjunction with this, the press button switches 102 and 103 are automatically turned OFF. Also, when the user presses the push button switch 102 to turn the speech transmission ON, the function selecting switch 61 is in the state #2. In conjunction with this, the press button switches 101 and 103 are automatically turned OFF. Also, when the user presses the push button switch 103, the function selecting switch 61 is in the state #3. In conjunction with this, the press button switches 101 and 102 are automatically turned OFF.

The function selecting unit 19 outputs a speech recognition operation signal to the speech recognition unit 23 while also outputting a speech transmission stop signal to the speech transmission section 53 if the state of the function selecting switch 61 is the state #1, or outputs a speech recognition stop signal to the speech recognition unit 23 while also outputting a speech transmission operation signal to the speech transmission section 53 if the state of the function selecting switch 61 is the state #2, or outputs a speech recognition stop signal to the speech recognition unit 23 while also outputting a speech transmission stop signal to the speech transmission section 53 if the state of the function selecting switch 61 is the state #3.

The operation of the speech recognition unit 23 is the same as in the first and second embodiment, and the operation of the speech transmission section 53 is the same as in the second embodiment.

When the user selected not to carry out the processing of both the speech recognition unit 23 and the speech transmission section 53, that is, when the state of the function selecting switch 61 is the state #3, both the recognition target signal breaker 41 and the transmission target signal breaker 55 are opening according to the speech recognition stop signal and the speech transmission stop signal. Consequently, the processing by the acoustic analysis unit 43, the model matching unit 45, the recognition result transmission unit 25, the speech coding unit 57, and the speech transmission unit 59 will not be carried out, and the amount of calculations is reduced considerably.

When the CPU that realizes the acoustic analysis unit 43, the model matching unit 45, the speech coding unit 57 and the speech transmission unit 59 has a power saving mode, it is possible for the CPU to make a transition to the power saving mode when the user selected the OFF mode (that is, when the function selecting switch 61 is in the state #3 or when the speech recognition stop signal and the speech transmission stop signal are detected). In the power saving mode, the computational power and the power consumption of the CPU are reduced to save the power so that the load on the battery is reduced and it becomes possible to prolong the operable period of the headset. When the function selecting switch 61 comes out of the state #3, or when at least one of the speech recognition operation signal and the speech transmission operation signal is outputted, the CPU makes the transition to the ordinary mode immediately such that the normal computational power becomes available.

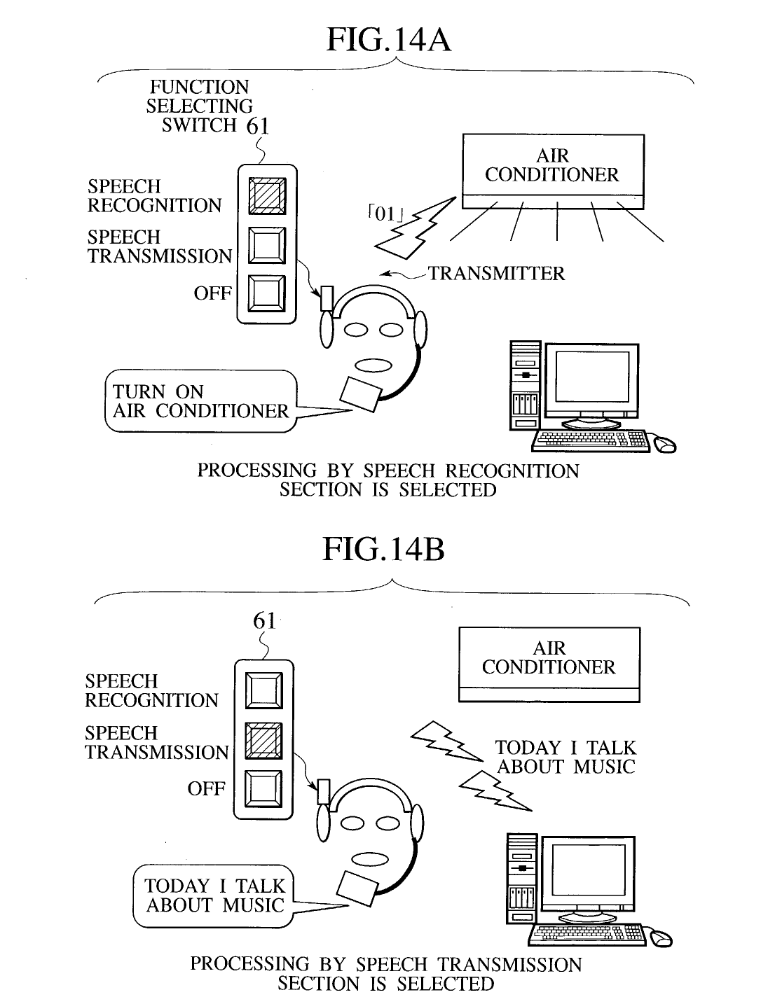

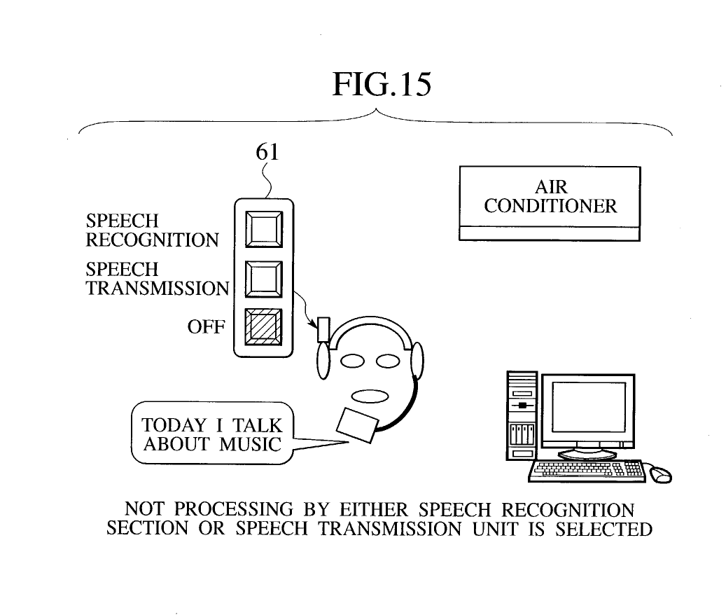

FIGS. 14A and 14B and FIG. 15 show exemplary operations of the headset with the radio communication function according to the third embodiment. Here, similarly as in the second embodiment, the exemplary case where the user wearing the headset carries out the controls by the speech commands or the speech data transmission with respect to an air conditioner and a PC which are located inside a room will be described.

The memory contents of the recognition vocabulary memory unit 47 and the acoustic model production and memory unit 49 of the speech recognition unit 23 as well as the memory content on the air conditioner side are assumed to be the same as in the first and second embodiments. It is also assumed that, similarly as in the second embodiment, the PC is connected to a large capacity hard disk, and the speech data received from the headset with the radio communication function are all stored into this hard disk.

FIG. 14A shows the case where the user uttered the speech command “turn on air conditioner” toward the microphone in the state where the speech recognition processing mode is selected by the function selecting switch 61. The speech uttered by the user is detected by the microphone, and converted into the digital signal by the A/D converter 21. The digital signal is split into two, and one is inputted into the speech recognition unit 23 while the other one is inputted into the speech transmission section 53.

As the state of the function selecting switch 61 is the state #1, the function selecting unit 19 outputs the speech recognition operation signal to the speech recognition unit 23, and outputs the speech transmission stop signal to the speech transmission section 53. In this case, similarly as in the second embodiment (FIG. 11A), the command “01” is transmitted to the air conditioner by radio such that the air conditioner starts its operation. On the other hand, the speech data are not transferred to the PC.

FIG. 14B shows the case where the user uttered the speech “Today I talk about music” in the state where the speech transmission processing mode is selected by the function selecting switch 61. The speech uttered by the user is detected by the microphone, and converted into the digital signal by the A/D converter 21. The digital signal is split into two, and one is inputted into the speech recognition unit 23 while the other one is inputted into the speech transmission section 53.

As the state of the function selecting switch 61 is the state #2, the function selecting unit 19 outputs the speech recognition stop signal to the speech recognition unit 23, and outputs the speech transmission operation signal to the speech transmission section 53. Here, similarly as in the second embodiment (FIG. 11B), nothing is transmitted to the air conditioner, while the coded speech signal is transmitted to the PC. In this way, the user can record the uttered speech in a memory inside the PC, for example. In the case where a table of the command words and the word IDs is also provided at the PC side, the user can transmit the already speech recognition processed speech command to the PC by radio at a time of recording, so as to turn ON the PC.

FIG. 15 shows the case where the user uttered the speech “Today I talk about music” in the state where the OFF mode, i.e., not to carry out either the speech recognition processing or the speech transmission processing, is selected by the function selecting switch 61. The speech uttered by the user is detected by the microphone, and converted into the digital signal by the A/D converter 21. The digital signal is split into two, and one is inputted into the speech recognition unit 23 while the other one is inputted into the speech transmission section 53.

As the state of the function selecting switch 61 is the state #3, the function selecting unit 19 outputs the speech recognition stop signal to the speech recognition unit 23, and outputs the speech transmission stop signal to the speech transmission section 53.

The digital signal inputted into the speech recognition unit 23 is first inputted into the recognition target signal breaker 41, but the recognition target signal breaker 41 is opening as the function selecting unit 19 outputs the speech recognition stop signal. Consequently, the digital signal is not inputted into the acoustic analysis unit 43 and the subsequent processing is not carried out.

Similarly, the digital signal inputted into the speech transmission section 53 is first inputted into the transmission target signal breaker 55, but the transmission target signal breaker 55 is opening as the function selecting unit 19 outputs the speech transmission stop signal. Consequently, the digital signal is not inputted into the speech coding unit 57 and the subsequent processing is not carried out.

Thus, no speech control signal is transmitted to the air conditioner, and no speech data is transmitted to the PC. However, the user can still use the functions not aimed at the speech recognition processing and the operation based on it such as the control of the other device or the dictation. Consequently, the user can hear the voice of the third person or the music from the speakers provided inside the headset.

(Fourth Embodiment)

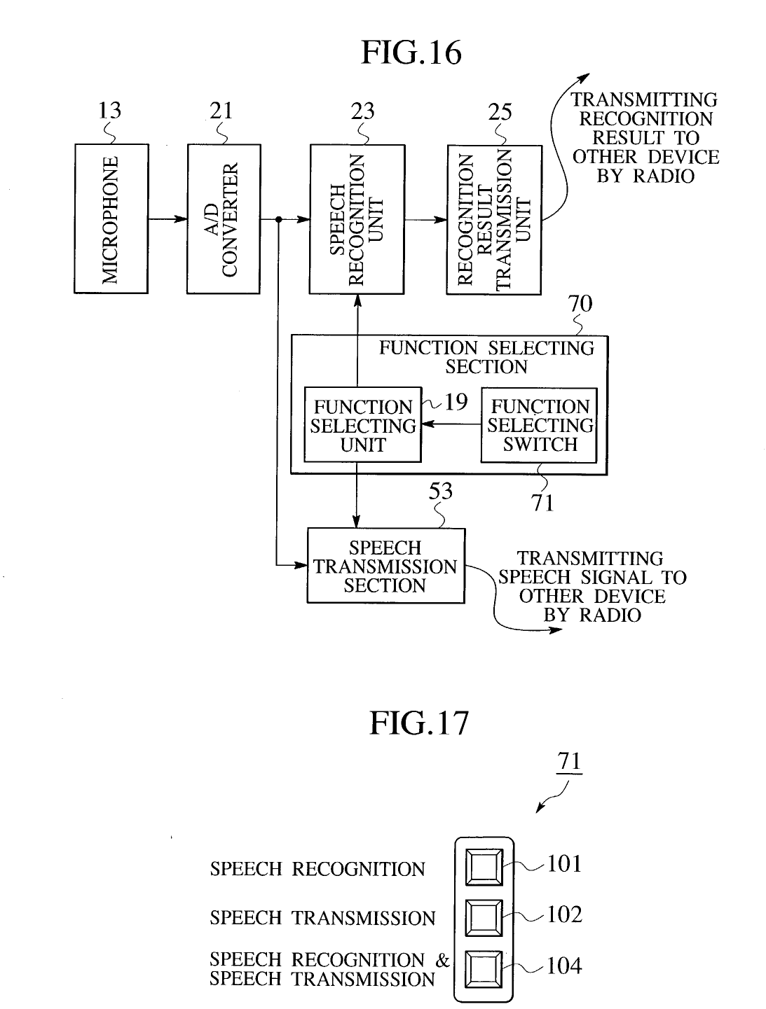

FIG. 16 and FIG. 17 show a system configuration of the headset according to the fourth embodiment of the present invention.

First, the speech signal detected by the microphone 13 is inputted into the A/D converter 21, and converted from the analog signal to the digital speech signal. The digital speech signal is split into two parts, and one is inputted into the speech recognition unit 23 while the other one is inputted into a speech transmission section 53.

As shown in FIG. 16 and FIG. 17, a function selecting section 70 is formed by a function selecting switch 71 and the function selecting unit 19. The user can switch three states by operating the function selecting switch 71 according to the need. Here, the case where the user selected the speech recognition processing of the speech signal detected by the microphone 13 is referred to as a state #1, the case where the user selected the speech transmission processing of the speech signal detected by the microphone 13 is referred to as a state #2, and the case where the user selected to process the speech signal detected by the microphone 13 at both the speech recognition unit 23 and the speech transmission section 53 is referred to as a state #3.

FIG. 17 shows an example of the function selecting switch 71. The function selecting switch 71 has three push button switches, for example, and it is a type of the switch in which any one of them is always ON. When the user presses the push button switch 101 to turn it ON, the function selecting switch 71 is in the state #1. In conjunction with this, the press button switches 102 and 103 are automatically turned OFF. Also, when the user presses the push button switch 102 to turn it ON, the function selecting switch 71 is in the state #2. In conjunction with this, the press button switches 101 and 103 are automatically turned OFF. Also, when the user presses the push button switch 103, the function selecting switch 71 is in the state #3. In conjunction with this, the press button switches 101 and 102 are automatically turned OFF.

The function selecting unit 19 outputs a speech recognition operation signal to the speech recognition unit 23 while also outputting a speech transmission stop signal to the speech transmission section 53 if the state of the function selecting switch 71 is the state #1, or outputs a speech recognition stop signal to the speech recognition unit 23 while also outputting a speech transmission operation signal to the speech transmission section 53 if the state of the function selecting switch 71 is the state #2, or outputs a speech recognition operation signal to the speech recognition unit 23 while also outputting a speech transmission operation signal to the speech transmission section 53 if the state of the function selecting switch 71 is the state #3.

The operations of the speech recognition unit 23 and the speech transmission section 53 are the same as in the above described embodiments.

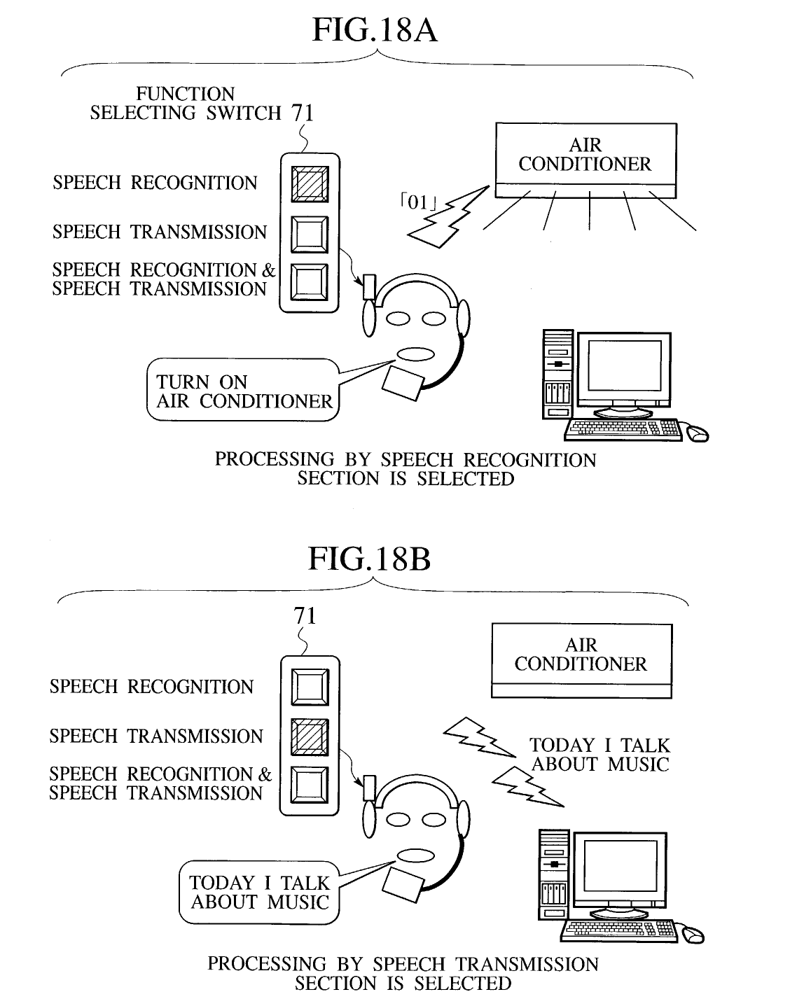

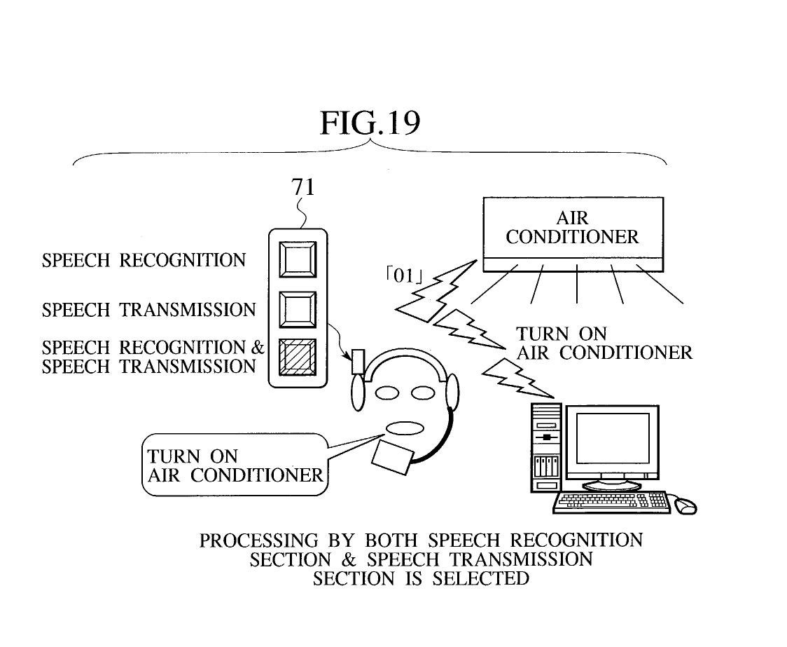

FIGS. 18A and 18B and FIG. 19 show exemplary operations of the headset with the radio communication function according to the fourth embodiment. Here, similarly as in the third embodiment, the exemplary case where the user wearing the headset with the radio communication function selectively switches the speech recognition processing mode and the speech transmission processing mode by the function selecting switch 71, to carry out the speech controls of the air conditioner and the speech data transmission and recording with respect to the PC will be described.

The memory contents of the recognition vocabulary memory unit 47 and the acoustic model production and memory unit 49 of the speech recognition unit 23 as well as the memory content on the air conditioner side are assumed to be the same as in the first embodiment. It is also assumed that, similarly as in the second embodiment, the PC is connected to a large capacity hard disk, and the speech data received from the headset with the radio communication function are all stored into this hard disk.

FIG. 19 shows the case where the user uttered “turn on air conditioner” in a state where the processing of the speech by both the speech recognition processing and the speech transmission processing is selected by the function selecting switch 71. The speech uttered by the user is detected by the microphone 13, and converted into the digital signal by the A/D converter 21. The digital signal is split into two, and one is inputted into the speech recognition unit 23 while the other one is inputted into the speech transmission section 53.

As the state of the function selecting switch 61 is the state #3, the function selecting unit 19 outputs the speech recognition operation signal to the speech recognition unit 23, and outputs the speech transmission operation signal to the speech transmission section 53.

The digital signal inputted into the speech recognition unit 23 is first inputted into the recognition target signal breaker 41, and the recognition target signal breaker 41 is closed as the function selecting unit 19 outputs the speech recognition operation signal. Consequently, the digital signal is inputted into the acoustic analysis unit 43, and the recognition result “01” is transmitted to the air conditioner by radio and the air conditioner starts its operation.

On the other hand, the digital signal inputted into the speech transmission section 53 is first inputted into the transmission target signal breaker 55, and the transmission target signal breaker 55 is closed as the function selecting unit 19 outputs the speech transmission operation signal. Consequently, the digital signal is inputted into the speech coding unit 57 and the coded speech signal is transmitted to the PC by radio.

In this case, the speech data stored in the PC contains the speech components uttered in expectation that it is to be recognized by the speech recognition unit 23 of the headset with the radio communication function. Consequently, by reproducing the speech stored in the PC, it is possible to check the operation log of the speech recognition unit 23.

In the fourth embodiment, the speech uttered by the user is recognized as the speech command for the device control, while it is also processed as the speech data to be recorded and stored in the PC. With the headset in such a configuration, it becomes possible to carry out the remote control of a device or an instrument in a research facility or a factory by the speech commands without any key operations, while also recording that operation control record in the PC or the like. Also, the speech command processing based on the word recognition has been used as an example of the speech recognition processing within the headset, but the present invention is not limited to this example as already mentioned above.

(Fifth Embodiment)

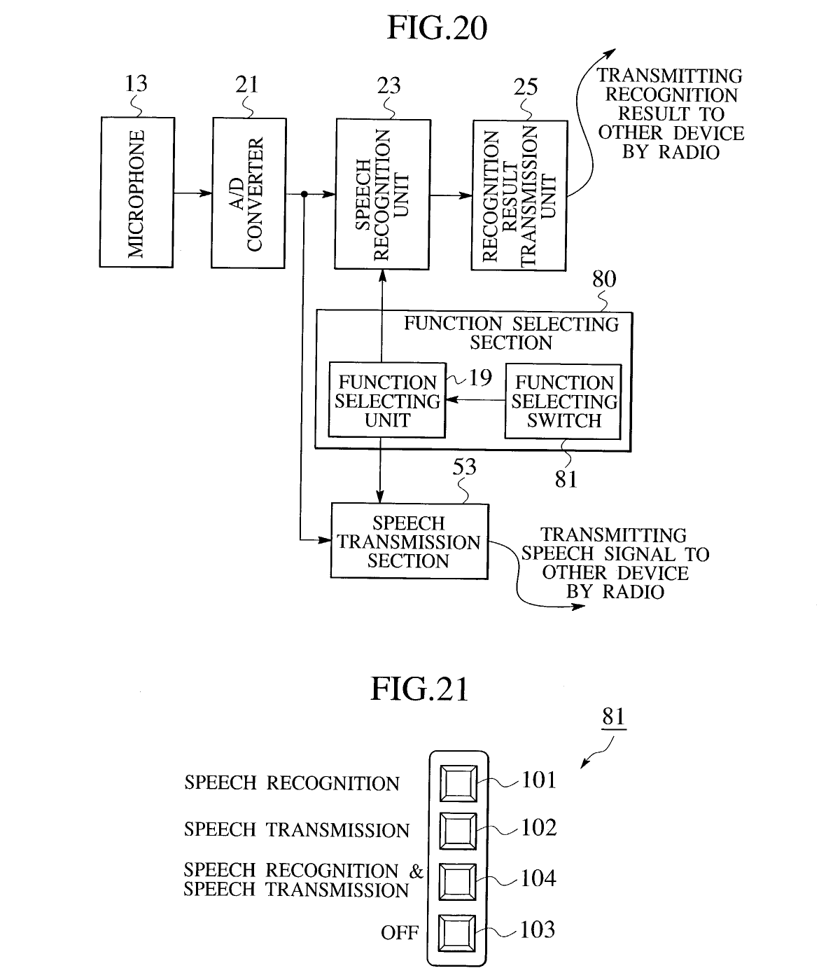

FIG. 20 and FIG. 21 show a system configuration of the headset according to the fifth embodiment of the present invention. The fifth embodiment is a combination of the third embodiment and the fourth embodiment described above, in which the function selecting switch has four modes including the speech recognition processing mode, the speech transmission processing mode, the speech recognition and speech transmission processing mode, and the OFF mode.

Similarly as in the third and fourth embodiments, the speech signal detected by the microphone 13 is inputted into the A/D converter 21, and converted from the analog signal to the digital speech signal. The digital speech signal is split into two parts, and one is inputted into the speech recognition unit 23 while the other one is inputted into a speech transmission section 53.

As shown in FIG. 20 and FIG. 21, a function selecting section 80 is formed by a function selecting switch 81 and the function selecting unit 19. The user can switch four states by operating the function selecting switch 81 according to the need. Here, the case where the user selected the speech recognition processing of the speech signal detected by the microphone 13 is referred to as a state #1, the case where the user selected the speech transmission processing of the speech signal detected by the microphone 13 is referred to as a state #2, the case where the user selected to process the speech signal detected by the microphone 13 at both the speech recognition unit 23 and the speech transmission section 53 is referred to as a state #3, and the case where the user selected not to process the speech detected by the microphone 13 at either the speech recognition unit 23 or the speech transmission section 53 is referred to as a state #4.

FIG. 18 shows an example of the function selecting switch 81. The function selecting switch 81 has four push button switches, for example, and it is a type of the switch in which any one of them is always ON. When the user presses the push button switch 101 to turn it ON, the function selecting switch 81 is in the state #1. In conjunction with this, the press button switches 102, 103 and 104 are automatically turned OFF. Also, when the user presses the push button switch 102 to turn it ON, the function selecting switch 81 is in the state #2. In conjunction with this, the press button switches 101, 103 and 104 are automatically turned OFF. Also, when the user presses the push button switch 103, the function selecting switch 81 is in the state #3. In conjunction with this, the press button switches 101, 102 and 104 are automatically turned OFF. Also, when the user presses the push button switch 104, the function selecting switch 81 is in the state #4. In conjunction with this, the press button switches 101, 102 and 103 are automatically turned OFF.

The signal output states of the function selecting unit 19 corresponding to the states (modes) of the function selecting switch 81, the operations of the signal breakers 41 and 55 corresponding to them, as well as the word ID to be transmitted by radio are the same as the third and fourth embodiments so that their description will be omitted here.

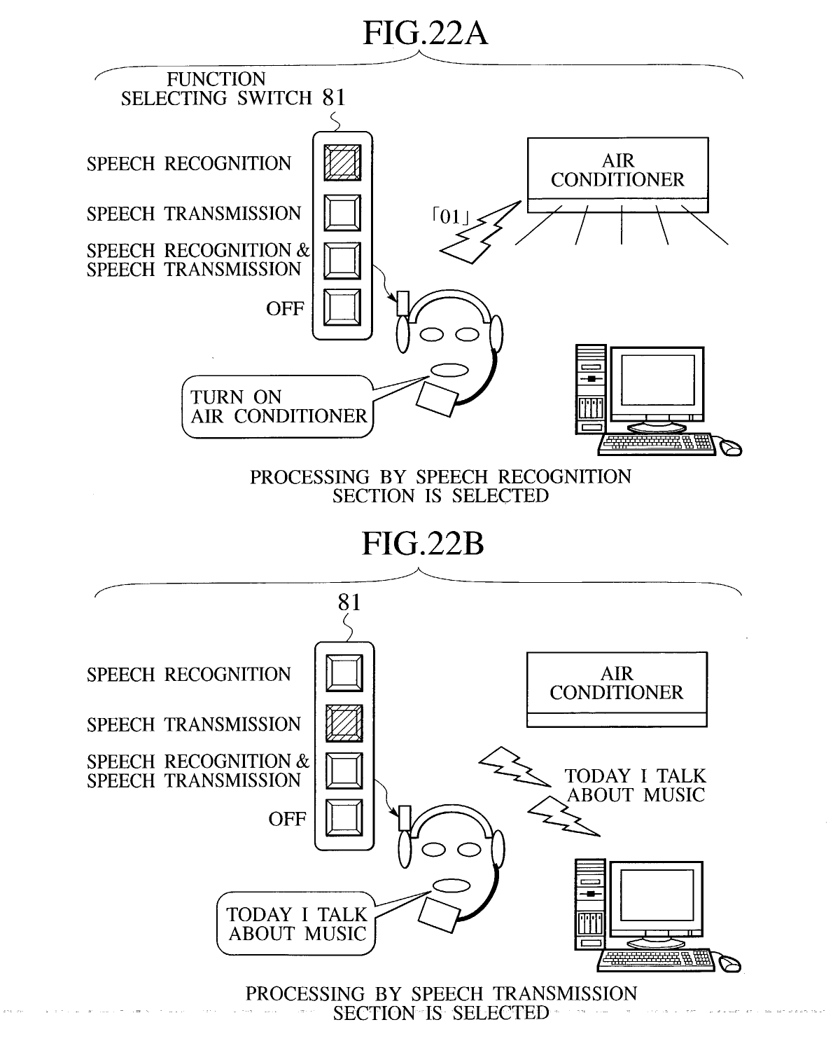

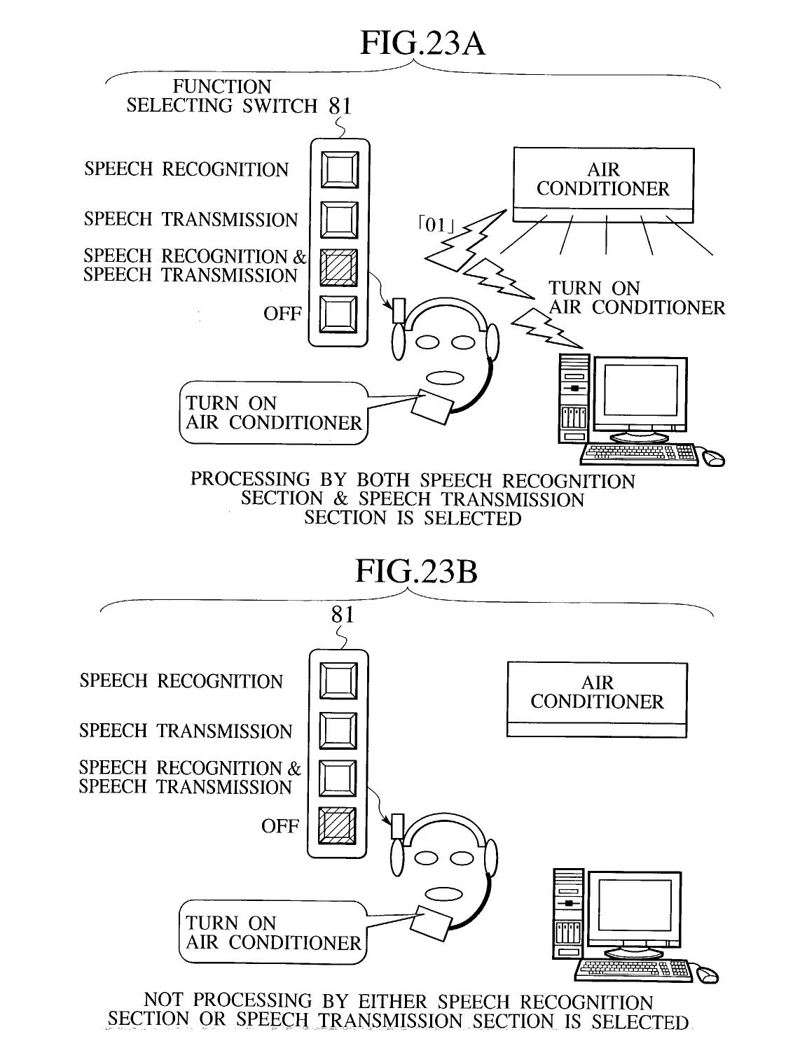

FIGS. 22A and 22B and FIGS. 23A and 23B show exemplary operations of the headset with the radio communication function according to the fifth embodiment. The user wearing the headset can select any of the four modes by operating the function selecting switch 81 according to the need. FIGS. 22A and 22B show the exemplary cases where the user selectively switches the speech recognition processing mode and the speech transmission processing mode by the function selecting switch 81, to carry out the speech controls of the air conditioner and the speech data transmission and recording with respect to the PC.

FIGS. 23A and 23B respectively show the case of processing the speech by both the speech recognition processing and the speech transmission processing is selected by the function selecting switch 81, and the case of not processing the speech by either the speech recognition processing or the speech transmission processing is selected by the function selecting switch 81. Similarly as described in the third and fourth embodiments, in the case of FIG. 23A, the air conditioner is controlled by the speech command while that speech is transmitted to the PC by radio as coded data and stored therein. The stored data can be reproduced and analyzed afterward. In the OFF mode, neither the speech recognition nor the speech transmission is carried out, but the user can hear the voice of the third person or the music from the speakers provided inside the headset.

Note that, in the fifth embodiment, the memory contents of the recognition vocabulary memory unit 47 and the acoustic model production and memory unit 49 of the speech recognition unit 23 as well as the memory content on the air conditioner side are assumed to be the same as in the first embodiment. It is also assumed that, similarly as in the second embodiment, the PC is connected to a large capacity hard disk, and the speech data received from the headset with the radio communication function are all stored into this hard disk.

(Sixth Embodiment)

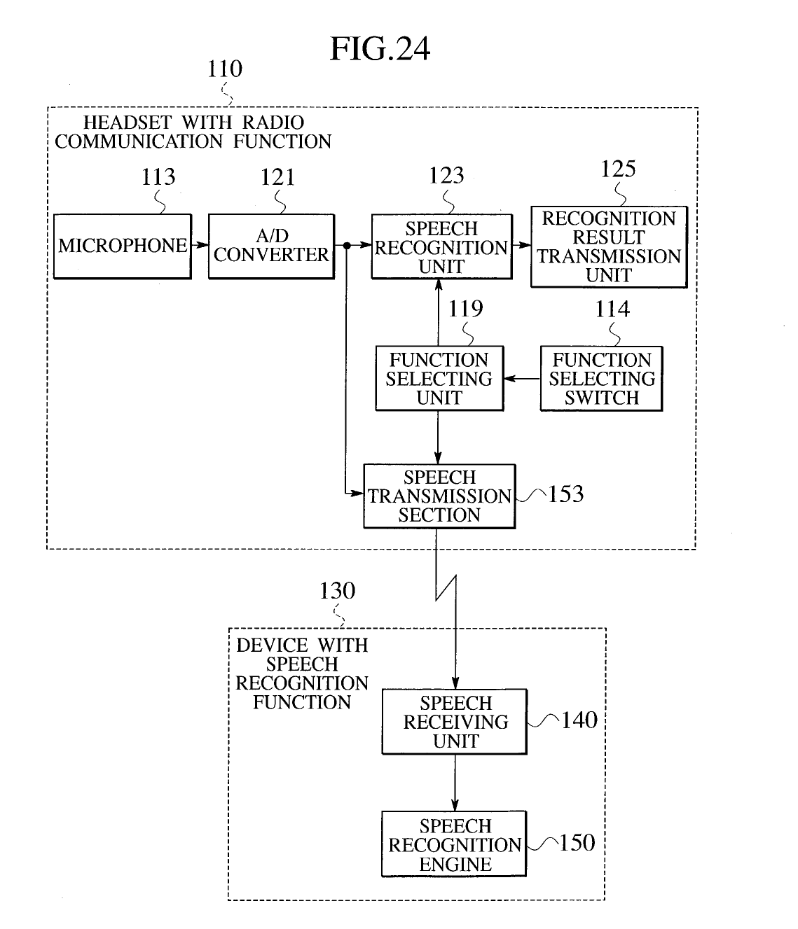

FIG. 24 shows a system configuration of the speech processing system according to the sixth embodiment of the present invention. This speech processing system comprises a headset 110 with the radio communication function as described in the first to fifth embodiments, and a device 130 with the speech recognition function. In this system, when the speech transmission processing mode is selected by a function selecting switch 114 of the headset 110, the speech signal detected by the microphone 113 is transmitted to the device 130 with the speech recognition function by radio through a speech transmission means 153, and applied with the speech recognition processing at the device side. When the speech recognition processing mode is selected at the headset 110, the speech recognition processing is carried out within the headset 110.

Namely, the headset 110 with the radio communication function has a microphone 113 for detecting the speech uttered by a user, a speech recognition unit 123 for carrying out the speech recognizing processing of the speech detected by the microphone 113, a recognition result transmission unit 125 for transmitting the recognition result of the speech recognition unit 123 by radio, a speech transmission section 153 for transmitting the speech signal detected by the microphone 113 as the coded speech data by radio, and a function selecting switch 114 for selecting either one of the speech recognition processing and the speech transmission processing.

On the other hand, the device 130 with the speech recognition function has a speech receiving unit 140 for receiving the speech data transmitted by radio from the headset 110 and a speech recognition engine 150 for applying the speech recognition processing to the received speech.

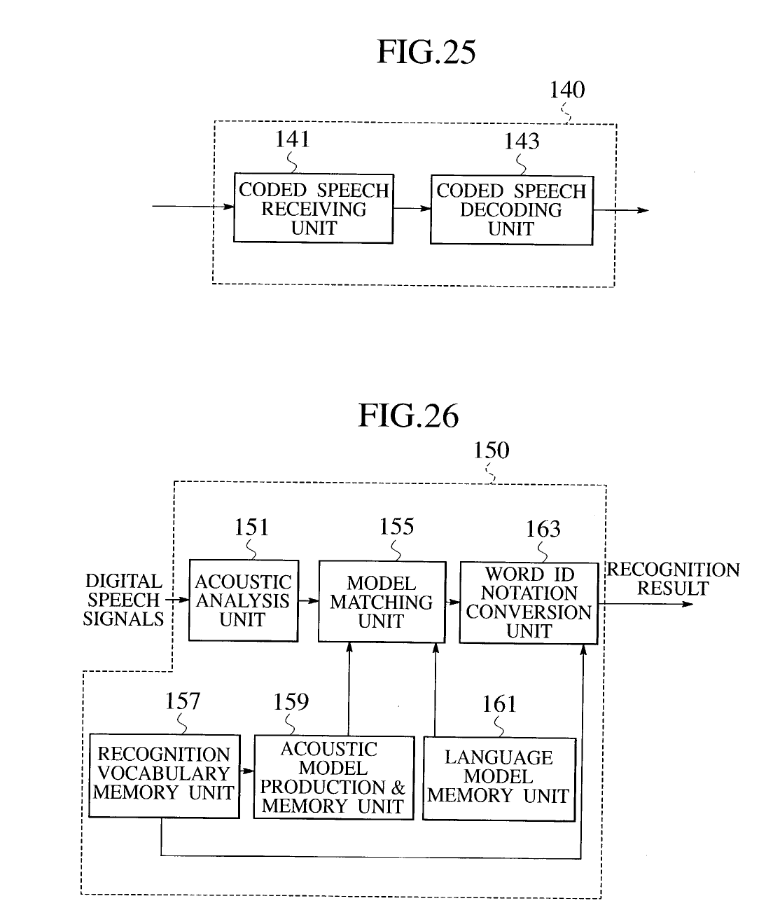

FIG. 25 shows the speech receiving unit 140 of the device 130 with the speech recognition function shown in FIG. 24. The coded speech signal transmitted by radio from the headset 110 is received by a coded speech receiving unit 141, and inputted into a coded speech decoding unit 143. The coded speech decoding unit 143 carries out the the coded speech decoding processing, and outputs the digital speech signal to the speech recognition engine 150.

The speech recognition engine 150 can utilize either the word speech recognition technique or the large vocabulary sentence speech recognition technique. Here, the exemplary case of using the large vocabulary sentence speech recognition technique will be described.

FIG. 26 shows a configuration of the speech recognition engine 150 using the sentence speech recognition technique. In the speech recognition engine 150, the vocabularies that are potentially used in the input speeches are collected in advance. For example, in the case of using the vocabulary in word units, the notation, pronunciation, and word ID of each word are stored in a recognition vocabulary memory unit 157. Usually, approximately several tens of thousand to one hundred thousand words are stored as such words, but when it is possible to limit topics or sentence patterns, it is possible to narrow down the number of words and reduce the memory capacity.

Also, the language model indicating the likelihood of relationship among those words stored in the recognition vocabulary memory unit 157 is produced and stored in a language model memory unit 161 in advance. For this language model, it is possible to use the frequency of appearance of each word in a database of sentences that are collected in a large number, or the probability obtained according to the frequency of appearance of two word pair and/or three word set, for example.

An acoustic model production and memory unit 159 produces the word acoustic model from the pronunciation of each word stored in the recognition vocabulary memory unit 157, and stores a set of the word acoustic model and the word ID of each word. Here, as the word acoustic model, the generally well known HMM (Hidden Markov Model) is often used, but it is possible to use any word acoustic model.

An acoustic analysis unit 151 converts the inputted speech into feature parameters. The representative feature parameters often used in the speech recognition include the power spectrum that can be obtained by the band-pass filter or the Fourier transform, and the cepstrum coefficients that can be obtained by the LPC (Linear Predictive Coding) analysis, but the types of the feature parameters to be used can be any of them. The acoustic analysis unit 151 converts the input speeches for a prescribed period of time into the feature parameters. Consequently, its output is a time series of the feature parameters (feature parameter sequence).

A model matching unit 155 calculates a similarity or a distance between the consecutive word acoustic model concatenating the word acoustic models of the words stored in the acoustic model production and memory unit 159 and the inputted feature parameter sequence, to calculate the acoustic similarity (distance). Also, the arrangement of the words constituting the consecutive word acoustic model and the language model stored in the language model memory unit 161 are matched to calculate the linguistic likelihood. Then, the word sequence that matches best with the inputted feature parameter sequence is obtained by taking the acoustic similarity and the linguistic likelihood into account, and outputs a word ID sequence of words constituting that word sequence as a recognition result to a word ID notation conversion unit.

The word ID notation conversion unit 163 matches the word ID sequence with the word IDs and the notations stored in the recognition vocabulary memory unit 157, and converts the word ID sequence into a corresponding character string by concatenating the notations.

FIG. 27 shows the exemplary operation of the speech processing system shown in FIG. 24 and FIG. 25. In the example of FIG. 27, the user wearing the headset with the radio communication function selects the speech transmission processing mode by the function selecting switch 114, to transfer the uttered speech to the device with the speech recognition function (PC).

The speech “Today I talk about music” uttered by the user is detected by the microphone 113, encoded, and transferred to the PC from the speech transmission section 153. The PC decodes the received speech, and carries out the speech recognition processing. At the PC side, the notation and the pronunciation of each word is stored in correspondence to the word ID in the recognition vocabulary memory unit 157 of the speech recognition engine 150.

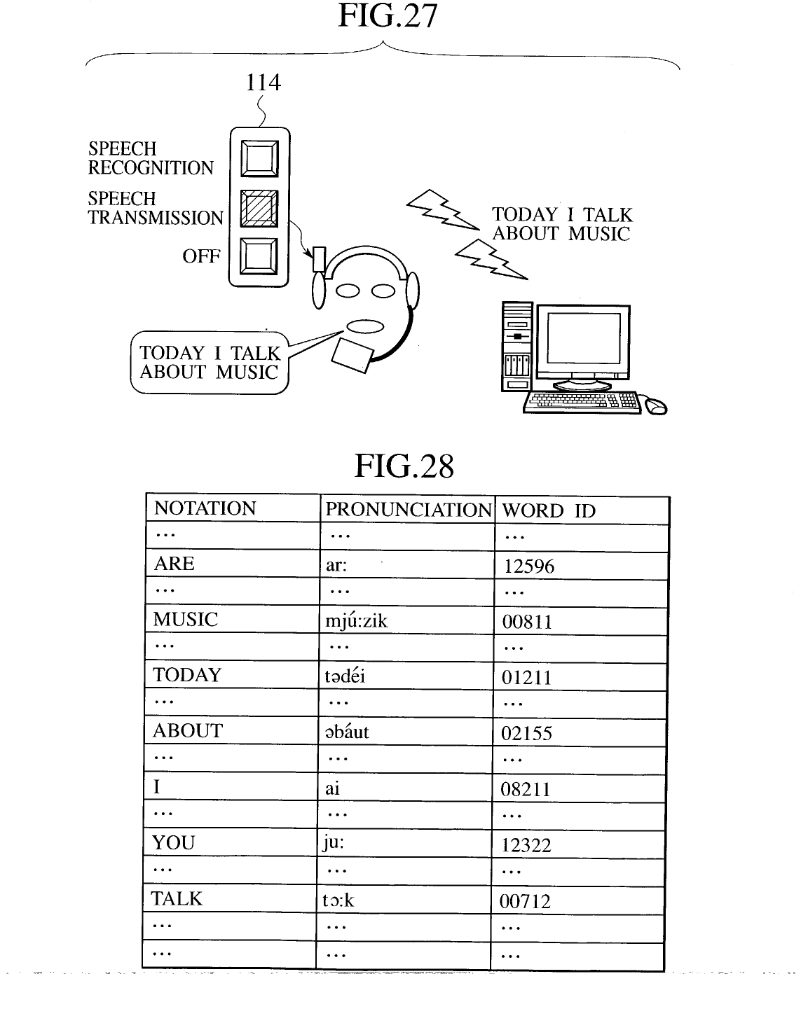

FIG. 28 shows an exemplary memory content of the recognition vocabulary memory unit 157. For example, in correspondence to the notation “music”, the pronunciation “mju:zik” and the word ID “00811” are registered. The acoustic model production and memory unit 159 produces and stores the word acoustic model corresponding to “music” according to the memory content of the recognition vocabulary memory unit 157.

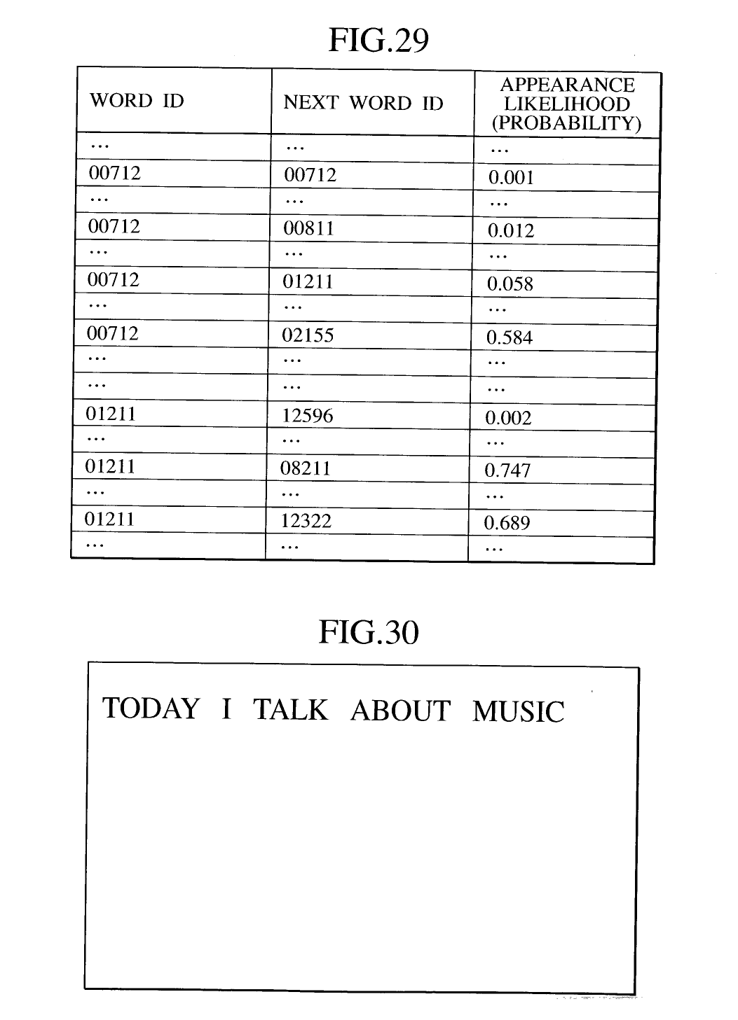

FIG. 29 shows an exemplary memory content of the language model memory unit 161. In the exemplary memory content shown in FIG. 29, the first word ID and the second word ID of the immediately following word of the first word are stored in correspondence to a rate (appearance likelihood) by which the word indicated by the second word ID appears immediately after the word indicated by the first word ID. For example, the rate (appearance likelihood) by which the word with the word ID “00811” is used immediately after the word with the word ID “00712” is indicated as 0.012. Also, the rate (appearance likelihood) by which the word with the word ID “02155” is used immediately after the word with the word ID “00712” is indicated as 0.584.

By referring to the memory content of the recognition vocabulary memory unit 157, it can be seen that the combinations of the word IDs mentioned above corresponds to “talk” “music” and “talk” “about”. By comparing their appearance likelihoods, it can be seen that the latter combination has a higher probability to appear consecutively than the former combination. Consequently, the character string “talk about” will be selected at higher priority.

Returning to FIG. 25 and FIG. 26, the speech transferred from the headset is received by the coded speech receiving unit 141 of the PC, decoded into the speech signal by the coded speech decoding unit 143, and inputted into the speech recognition engine 150.

The decoded speech signal is converted into the feature parameter sequence by the acoustic analysis unit 151, and inputted into the model matching unit 155. The model matching unit 153 obtains the word ID sequence corresponding to the feature parameter sequence according to the acoustic model of each word stored in the acoustic model production and memory unit 159 and the language model stored in the language model memory unit 161. In this case, the obtained word ID sequence is “01211, 08211, 00712, 02155, 00811”.

The word ID notation conversion unit 163 obtains the notations corresponding to the word IDs in the above word ID sequence, and concatenate these notations to obtain the character string “Today I talk about music”.

In the case where the device 130 with the speech recognition function has a function for displaying characters, the character string obtained by the word ID notation conversion unit 163 can be displayed on the device 130 with the speech recognition function such that the user can check the uttered content in a form of the character string at the spot. FIG. 30 shows an exemplary display of the character string as text by the PC.

Also, in the case where the device 130 with the speech recognition function has an editing function, the real time editing at the spot can be carried out. In this case, the working efficiency can be remarkably improved compared with the case of storing the speech signal, converting it into the character string and editing it later on.

In addition, it is possible to carry out the editing operation by the speeches, by switching the function selecting switch 114 of the headset 110 with the radio communication function such that the the speech recognition is carried out by the speech recognition unit 123 of the headset itself, recognizing the editing command speeches there, and transmitting the recognition result by radio to the device 130 with the speech recognition function. Because the function selecting switch 114 is provided on the headset, the effort required in switching the processing mode does not cause any problem here. It is also possible to omit the switching of the switch by adding a function for recognizing the command speeches to the device 130 with the speech recognition function. However, in this case, there is also a need to add a function for judging whether the input speech is the speech for which the character string is to be displayed or the editing command, to the device 130 with the speech recognition function.

Also, in the case where the device 130 with the speech recognition function has a function for storing the character string, it is possible to store the result of the conversion into the character string at the spot. With this configuration, the uttered content can be recorded by the memory capacity smaller than that required in the case of storing the speech. Also, as it is converted into the character string, the search or the like becomes easier. By storing the decoded speech and the character string as a set, the usefulness can be improved further. More specifically, it becomes possible to search the character string by using the searching character string, and reproduce the speech corresponding to the character string found by the search.

Also, in the case where the speech recognition engine 150 of the device 130 with the speech recognition function uses the word speech recognition technique, it is possible to control the device 130 with the speech recognition function by using the recognition result. For example, when the device with the speech recognition function is a PC and the application software is activated on the PC, the application can be operated by the speeches.

(Seventh Embodiment)

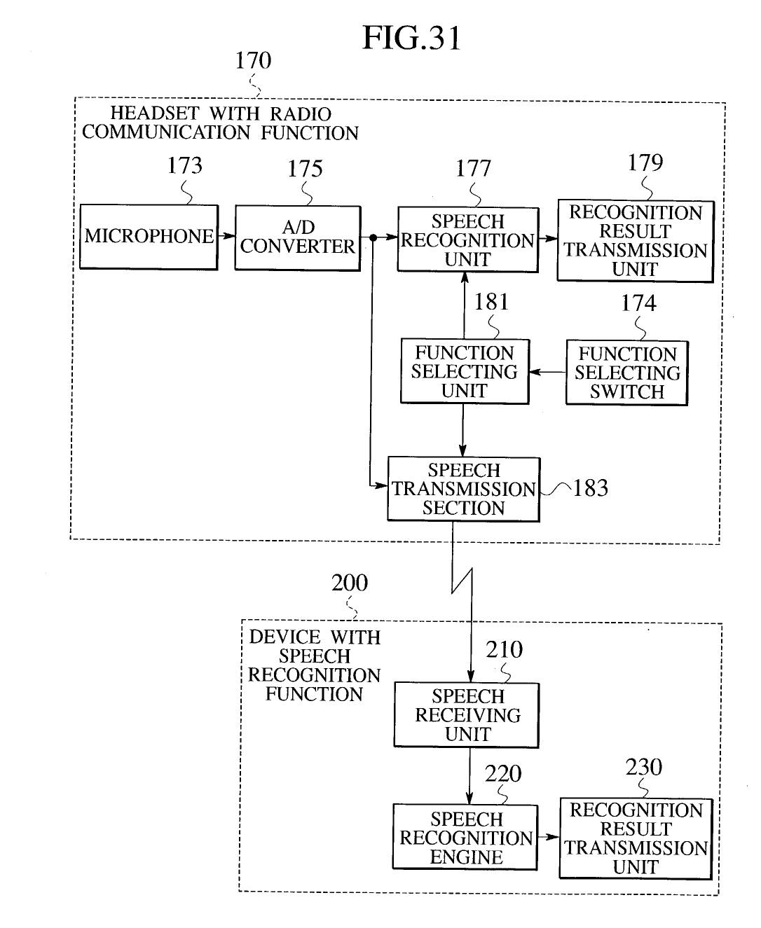

FIG. 31 shows a system configuration of the speech processing system according to the seventh embodiment of the present invention. This speech processing system comprises a headset 170 with the radio communication function, a device 200 with the speech recognition function as a first device, and a device (not shown) capable of carrying out radio communications with this device 200 with the speech recognition function. The device 200 with the speech recognition function has a speech receiving unit 210, a speech recognition engine 220, and a recognition result transmission unit 230 for transmitting the recognition result by radio to the second device.

The speech receiving unit 210 is similar to the speech receiving unit 140 of FIG. 24. The speech recognition engine 220 can use either one of the word speech recognition technique and the large vocabulary sentence speech recognition technique. Here, it is assumed that the word speech recognition technique is used.

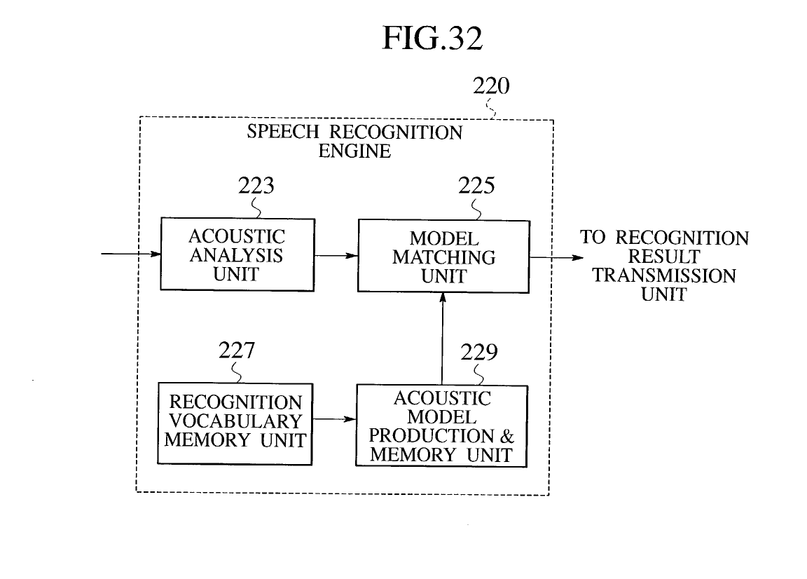

FIG. 32 shows a configuration of the speech recognition engine 220 in the case of utilizing the word speech recognition technique. An acoustic analysis unit 223, a model matching unit 225, a recognition vocabulary memory unit 227, and an acoustic model production and memory unit 229 are similar to those used in the speech recognition unit provided in the headset 10 with the radio communication function of the first embodiment.

The word ID outputted from the speech recognition engine 220 as the recognition result is inputted into the recognition result transmission unit 230. The recognition result transmission unit 230 transmits the received word ID to the other device. A method for transmitting to the other device can be the radio communication, the wire communication, etc., and it can be realized in any suitable way.

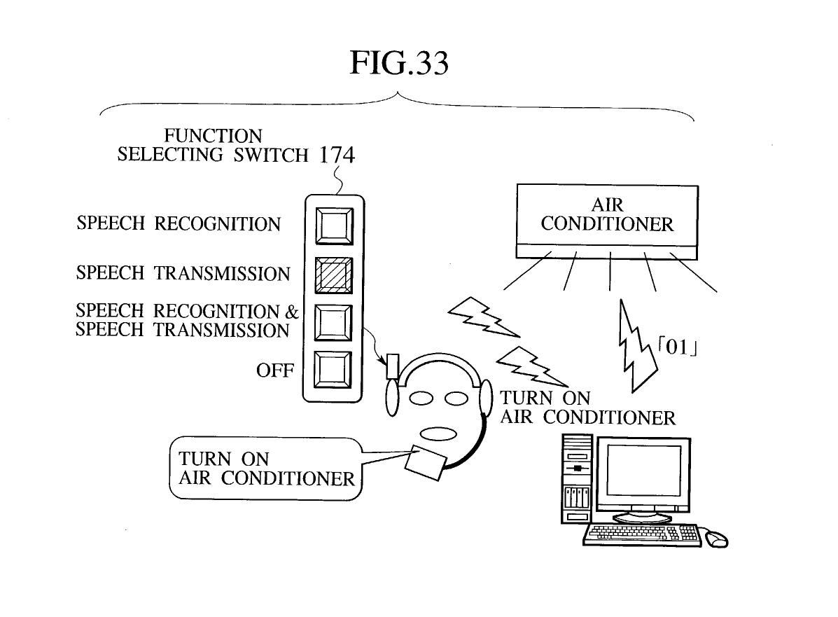

FIG. 33 shows an exemplary operation of the speech processing system of FIG. 31. The user wearing the headset 170 with the radio communication function carries out the speech control of the air conditioner as the second device, through the PC with the speech recognition function as the first device.

The user is selecting the speech transmission processing mode by the function selecting switch 174 of the headset. Consequently, the speech “turn on air conditioner” detected by the microphone 173 is coding processed by the speech transmission unit 183 and transferred by the radio communication to the PC.

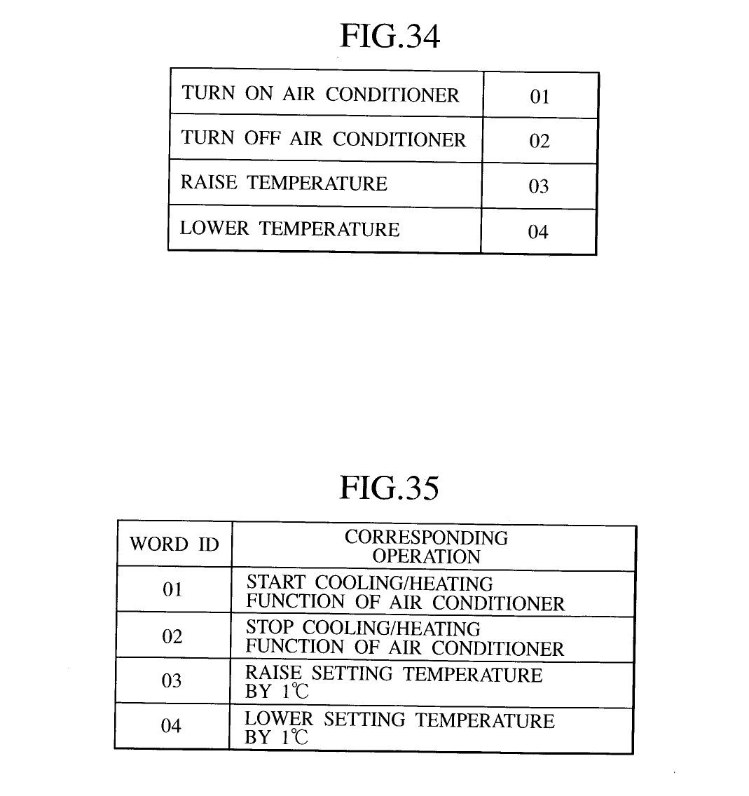

FIG. 34 shows an exemplary memory content of the recognition vocabulary memory unit 227 provided in the PC. In the example of FIG. 34, the recognition vocabulary including “turn on air conditioner”, “turn off air conditioner”, “raise temperature”, and “lower temperature”, and the word IDs “01”, “02”, “03”, and “04” assigned to them respectively, are stored. In the case where speech “turn on air conditioner” is recognized by the PC, the word ID “01” is transmitted by radio to the air conditioner.

According to the memory content of the recognition vocabulary memory unit 227, the memory content of the acoustic model production and memory unit 229 is produced. In the case of the exemplary memory content shown in FIG. 34, the acoustic models for the speeches “turn on air conditioner”, “turn off air conditioner”, “raise temperature”, and “lower temperature” are produced, and stored in correspondence to the respective word IDs.

On the other hand, the air conditioner stores a set of each word ID and its corresponding operation as shown in FIG. 35. Consequently, when the specific word ID is received, the air conditioner carries out the operation corresponding to that word ID.

The coded speech received by the speech receiving unit 210 of the PC is converted into the speech signal by the coded speech decoding unit and inputted into the speech recognition unit 220. The speech signal is converted into the feature parameter sequence by the acoustic analysis unit 223, and inputted into the model matching unit 225. The model matching unit 225 matches the inputted feature parameter sequence with the acoustic model of each word stored in the acoustic model production and memory unit 229. When the similarly of the acoustic model corresponding to “turn on air conditioner” becomes highest, the model matching unit 225 outputs the word ID “01” as the recognition result.

The word ID “01” is inputted into the recognition result transmission unit 230, and the word ID “01” is transmitted to the aid coditioner by the radio communication. When the word ID “01” is received, the air conditioner starts the operation of the cooling/heating function corresponding to this word ID according to the table of FIG. 35.

With this configuration, the speech of the user detected by the microphone 173 of the headset 170 with the radio communication function is recognized almost in real time by the device 200 with the speech recognition function, and the recognition result can be transmitted to the other device.

In the case where the device 200 with the speech recognition function is a device having a large computational power such as the PC, the speech recognition engine 220 has lesser functional limitations than the speech recognition unit 177 of the headset, so that the recognition vocabulary can be increased considerably, for example. Also, even when the speech recognition function of the device 200 with the speech recognition function becomes unavailable for some reason, it is possible to continue to the device operation using the speeches by switching the function selecting switch 174 such that the speech recognition processing is carried out by the speech recognition unit 177 of the headset.

In the case where the large vocabulary sentence speech recognition technique is used for the speech recognition engine 220 similarly as in the speech recognition engine 150 of FIG. 24, it becomes possible to transfer the character string conversion result immediately to the other device. The amount of communication necessary for transferring the character string is smaller than the amount of communication necessary for transferring the speech, so that it is possible to reduce the amount of communication. In this system, the recognition of the speech can be carried out almost simultaneously as the speech utterance. In the conventional technique for recognizing the stored speech and transferring the recognition result, the speech recognition technique is used after the speech utterance is completed, and then the recognition result is transferred so that the time delay inevitably occurs. In contrast, in this system of the sixth embodiment, the speech is recognized in parallel to the speech utterance by the user so that the time delay can be reduced.

In the above described embodiments, the exemplary case using the word speech recognition for the speech recognition within the headset or at the external device side, but the present invention is not limited to this exemplary case. In particular, for the speech recognition within the headset, it is possible to use any of the speech recognition that requires the small amount of calculations, the small memory capacity and the small power consumption such as the continuous word recognition, the sentence recognition, the word spotting, the speech intention comprehension, etc.

According to the present invention, the speech recognition unit, the speech transmission unit, and the function selecting unit for switching them are provided in the headset with the radio communication function, so that it is possible to provide the headset which is capable of carrying out the speech recognition according to the intention of the user, without restricting the user's action.

In the case where the simple and low power consumption type speech recognition is carried out within the headset and the speech data are transmitted to a device external of the headset, it is possible to carry out the accurate speech recognition which is more difficult to realize.

Also, the speech recognition processing function and the speech transmission processing function can be freely stopped temporarily according to the user's selection, so that it is possible to reduce the power consumption of the headset with the radio communication function.

In addition, in the case where the speech data are transferred from the headset to another device having a large capacity, it is possible to recognize the received speech in real time and carry out the text conversion, the editing, the storing, and the reproduction, at the another device. In this way, the usefulness of the system can be improved further.

In the present invention, the headset implemented with the radio communication function and the speech recognition function is regarded as a device closest to the human user in the era of wearable and ubiquitous, such that the improvement of the speech recognition performance and the enhancement of its application are realized while making it possible to provide the headset in a smaller size at a cheaper cost.

Also, by utilizing the headset and the speech input which are most familiar to the human being, the utilization of the information device system and the network by the aged persons and the handicapped persons can be accelerated, and it becomes possible to interact with various device systems and utilize the various service contents. As a result, the present invention can contribute to the activation of the various device system industry, information communication media industry, and service industry.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A headset with a radio communication function, comprising:
a microphone configured to detect a speech and generate a speech signal indicating the speech;
a speech recognition unit configured to recognize the speech indicated by the speech signal;
a recognition result transmission unit configured to transmit a recognition result obtained by the speech recognition unit to an external device by radio communication; and
a function selecting unit configured to enable a user of the headset to selectively control the speech processing unit to carry out a speech recognition processing of the speech signal generated by the microphone.

2. The headset of claim 1, wherein the function selecting unit enables the user to select whether or not to carry out the speech recognition processing of the speech signal generated by the microphone.

3. The headset of claim 1, further comprising:
a speech transmission unit configured to transmit the speech signal to the external device by radio communication;
wherein the function selecting unit enables the user to select either one of the speech recognition unit and the speech transmission unit to carry out a processing of the speech signal generated by the microphone.

4. The headset of claim 1, further comprising:
a speech transmission unit configured to transmit the speech signal to the external device by radio communication;
wherein the function selecting unit enables the user to select any one of three modes including a mode for carrying out a processing by the speech recognition unit, a mode for carrying out a processing by the speech transmission unit, and a mode for not carrying out a processing by either the speech recognition unit or the speech transmission unit.

5. The headset of claim 1, further comprising:
a speech transmission unit configured to transmit the speech signal to the external device by radio communication;
wherein the function selecting unit enables the user to select any one of three modes including a mode for carrying out a processing by the speech recognition unit, a mode for carrying out a processing by the speech transmission unit, and a mode for carrying out processings by both the speech recognition unit and the speech transmission unit.

6. The headset of claim 1, wherein the speech recognition unit recognizes the speech indicated by the speech signal within the headset and generates an identification signal corresponding to the speech as recognized from the speech signal, and the recognition result transmission unit transmits the identification signal as the recognition result to the external device by the radio communication.

7. The headset of claim 1, wherein the function selecting unit is a switch to be manually operated by the user.

8. A speech processing system, comprising:
a headset with a radio communication function, comprising: and
an external device capable of carrying out radio communication with the headset;
wherein the headset has:
a microphone configured to detect a speech of a user of the headset and generate a speech signal indicating the speech;
a speech recognition unit configured to recognize the speech indicated by the speech signal, and generate an identification signal corresponding to the speech as recognized from the speech signal; and
a recognition result transmission unit configured to transmit the identification signal generated by the speech recognition unit as a recognition result to the external device by radio communication, such that the external device carries out an operation corresponding to the identification signal received from the headset.

9. The speech processing system of claim 8, wherein the external device has a table for storing a plurality of identification signals in correspondence to operations corresponding to respective identification signals.

10. The speech processing system of claim 8, wherein the headset also has a function selecting unit configured to enable the user of the headset to selectively control the speech processing unit to carry out a speech recognition processing of the speech signal generated by the microphone.

11. A speech processing system, comprising:
a headset with a radio communication function, comprising: and
an external device capable of carrying out radio communication with the headset and having a speech recognition function;
wherein the headset has:
a microphone configured to detect a speech of a user of the headset and generate a speech signal indicating the speech;
a headset side speech recognition unit configured to recognize the speech indicated by the speech signal; and
a speech transmission unit configured to transmit the speech signal to the external device by radio communication; and
the external device has:
a speech receiving unit configured to receive the speech signal transmitted from the headset; and
a device side speech recognition unit configured to recognize the speech indicated by the speech signal.

12. The speech processing system of claim 11, wherein the external device carries out an operation corresponding to a recognition result obtained by the device side speech recognition unit.

13. The speech processing system of claim 11, wherein the external device also has a display unit,
the device side speech recognition unit recognizes the speech indicated by the speech signal, generates an identification signal corresponding to the speech as recognized from the speech signal, and outputs a character string converted from the identification signal, such that the display unit of the external device displays the character string as a recognition result of the device side speech recognition unit.

14. A speech processing system, comprising:
a headset with a radio communication function, comprising:
a first external device capable of carrying out radio communication with the headset and having a speech recognition function; and
a second external device capable of carrying out radio communication with the first external device;
wherein the headset has:
a microphone configured to detect a speech of a user of the headset and generate a speech signal indicating the speech;
a headset side speech recognition unit configured to recognize the speech indicated by the speech signal; and
a speech transmission unit configured to transmit the speech signal to the first external device by radio communication; and
the first external device has:
a speech receiving unit configured to receive the speech signal transmitted from the headset;
a device side speech recognition unit configured to recognize the speech indicated by the speech signal, and generate an identification signal corresponding to the speech as recognized from the speech signal; and
a recognition result transmission unit configured to transmit the identification signal as a recognition result to the second external device by radio communication, such that the second external device carries out an operation corresponding to the identification signal received from the first external device.
